(19) United States
(12) Patent Application Publication
(10) Pub. No.: US 2023/0158762 A1
(43) Pub. Date: May 25, 2023

(54) TIRE HAVING IMPROVED UNIFORMITY AND METHOD FOR MANUFACTURING SAME

(71) Applicant: COMPAGNIE GENERALE DES ETABLISSEMENTS MICHELIN, Clemont-Ferrand (FR)

(72) Inventors: PASCAL PROST, Clermont-Ferrand (FR); GAEL ROTY, Clermont-Ferrand (FR); OLIVIER MUHLHOFF, Clermont-Ferrand (FR)

(21) Appl. No.: 17/769,006

(22) PCT Filed: Oct. 9, 2020
(86) PCT No.: PCT/FR2020/051792

§ 371 Date: Apr. 14, 2022

(30) Foreign Application Priority Data
Oct. 16, 2019 (FR) FR1911531

(51) Int. Cl. B29D 30/24; B29D 30/30; B60C 9/06; B60C 9/08; B60C 9/22

(52) U.S. Cl. CPC B29D 30/245; B29D 30/3035; B29D 30/3007; B60C 9/06; B60C 9/08; B60C 9/2204; B60C 2009/2025

(57) ABSTRACT

A method for manufacturing a tire comprising a carcass reinforcement comprising a carcass layer and a working reinforcement comprising a single working layer comprising forming, around a support, a wound carcass assembly (52) intended to form the carcass layer and a wound working assembly intended to form the working layer, and then deforming the support. The wound carcass assembly (52) is formed so as to form either a junction (56) by abutment without forming a superposition, or a junction (56) by overlapping, or without forming a junction.

The present invention relates to a method for manufacturing a tyre and to a tyre obtained by this method.

Tyres are known from the prior art comprising a crown, two sidewalls and two beads, each sidewall connecting each bead to the crown. Each bead comprises at least one circumferential reinforcing element, generally in the form of a wire.

The tyre also comprises a carcass reinforcement anchored in each bead and extending in each sidewall and in the crown. The carcass reinforcement comprises a carcass layer comprising a portion wound around each circumferential reinforcing element. The carcass layer is axially delimited by two axial edges of the carcass layer and comprises carcass filamentary reinforcing elements extending axially from one axial edge to the other axial edge of the carcass layer. Each carcass filamentary reinforcing element extends in a main direction of each carcass filamentary reinforcing element forming, with the circumferential direction of the tyre, a constant angle ranging from 80° to 90° over the entire axial width of the carcass layer between the two axial edges of the carcass ply.

The crown comprises a tread intended to come into contact with the ground when the tyre is rolling as well as a crown reinforcement arranged radially between the tread and the carcass reinforcement. The crown reinforcement comprises a working reinforcement comprising two working layers. Each working layer is axially delimited by two axial edges of said working layer and comprises working filamentary reinforcing elements extending axially from one axial edge to the other axial edge of said working layer, substantially parallel to one another in a main direction of the working filamentary reinforcing elements forming, with the circumferential direction of the tyre, an angle strictly greater than 10°, for example equal to 26°. The main direction of each working filamentary reinforcing element of one of the working layers and the main direction of each working filamentary reinforcing element of the other of the working layers form, with the circumferential direction of the tyre, in the portion of the tyre axially delimited by the axial edges of the working reinforcement, angles of opposite orientations, i.e. here +26° and −26°.

Generally, the crown reinforcement also comprises a hoop reinforcement arranged radially outside the working reinforcement, the hoop reinforcement being axially delimited by two axial edges and comprising at least one hooping filamentary reinforcing element wound circumferentially helically so as to extend axially from one axial edge to the other axial edge of the hoop reinforcement in a main direction of the or each hooping filamentary reinforcing element.

Traditionally and in a known manner, such a tyre is manufactured by implementing a plurality of steps of a manufacturing method using a deformable manufacturing support of substantially cylindrical shape around a main axis and which can also take a toric shape after deformation.

During this method, a sealing ply, generally based on butyl, is wound around the support having its substantially cylindrical shape around its main axis.

Then, radially outside the sealing ply, there is wound a carcass ply intended to form the carcass layer. The carcass ply is axially delimited by two axial edges of the carcass ply and comprises the carcass filamentary reinforcing elements extending substantially parallel to one another axially from one axial edge to the other axial edge of the carcass ply in a main direction of the carcass filamentary reinforcing elements forming, with the circumferential direction of the support, an initial angle of each carcass filamentary reinforcing element ranging from 80° to 90°.

During the step of winding the carcass ply, the carcass ply has two circumferential end edges extending axially from one axial edge to the other axial edge of the carcass ply. During the winding step, the carcass ply is wound so as to form a junction between the two circumferential end edges by overlapping so as to form a radial superposition between a plurality of carcass filamentary reinforcing elements of one of the circumferential end edges and a plurality of carcass filamentary reinforcing elements of the other of the circumferential end edges, over the entire width of the carcass ply between the two axial edges of the carcass ply.

Then, the two circumferential reinforcing elements are arranged around the carcass ply and each axial edge of the carcass ply is turned axially inwards so as to radially cover each circumferential reinforcing element by one of the axial edges of the carcass ply and to form a portion of the carcass ply wound around each circumferential reinforcing element.

An assembly of the sealing layer, the carcass ply and circumferential reinforcing elements of substantially cylindrical shape around the main axis of the support is then obtained.

Then, the assembly of substantially cylindrical shape is deformed so as to obtain an assembly of substantially toric shape so that the main direction of each carcass filamentary reinforcing element forms, with the circumferential direction of the support, a final angle of each carcass filamentary reinforcing element substantially constant over the entire width of the carcass ply between the two axial edges of the carcass ply and identical to the initial angle. During this deformation, the high number of carcass filamentary reinforcing elements of one of the circumferential end edges and the high number of carcass filamentary reinforcing elements of the other of the circumferential end edges located in the junction maintain the junction despite the circumferential forces exerted on the carcass ply. By using low numbers of carcass filamentary reinforcing elements overlapping radially in the junction, the deformation step would cause the junction to open and create a circumferential distance between the two circumferential end edges that cannot be controlled.

Then, two working plies intended to form the two working layers are successively wound, radially outside the carcass ply of substantially toric shape around the main axis of the support. Each working ply is axially delimited by two axial edges of the working ply and comprises the working filamentary reinforcing elements extending substantially parallel to one another axially from one axial edge to the other axial edge of the working ply in a main direction of the working filamentary reinforcing elements forming, with the circumferential direction of the support, an angle of the working filamentary reinforcing elements substantially equal to 26°.

Then, there are arranged, radially outside the radially outermost working ply, the hoop reinforcement and the tread. The assembly thus formed, called the green blank of the tyre due to the presence of crosslinkable compositions in the uncrosslinked state, is then placed in a crosslinking mould to proceed with the moulding of the green blank, in particular of the tyre tread patterns, as well as the crosslinking of the crosslinkable compositions.

It is noted that due to the high numbers of carcass filamentary reinforcing elements overlapping radially in the junction, the tyre obtained presents on the one hand appearance defects on the sidewalls, as explained in WO2019180352, and on the other hand high-speed uniformity defects, these defects being associated with the higher localized density of carcass filamentary reinforcing elements in the junction compared with the density of carcass filamentary reinforcing elements outside the junction.

The object of the invention is to provide a tyre which does not have the defects associated with the high density of carcass filamentary reinforcing elements located in the junction.

To this end, the invention relates to a method for manufacturing a tyre comprising a crown, two sidewalls and two beads, each sidewall connecting each bead to the crown, the tyre comprising a carcass reinforcement anchored in each bead and extending in each sidewall and radially internally at the crown, the carcass reinforcement comprising at least one carcass layer, the crown comprising:
a tread intended to come into contact with the ground when the tyre is rolling,
a crown reinforcement arranged radially between the tread and the carcass reinforcement, the crown reinforcement comprising a working reinforcement comprising a single working layer,
in which method:
there is formed, by winding a carcass ply or a plurality of carcass plies around a support having a substantially cylindrical shape around a main axis, at least one wound carcass assembly intended to form the carcass layer, the wound carcass assembly being axially delimited by two axial edges of the wound carcass assembly and comprising carcass filamentary reinforcing elements extending substantially parallel to one another axially from one axial edge to the other axial edge of the wound carcass assembly, each carcass filamentary reinforcing element extending, in the or each carcass ply, in a main direction of each carcass filamentary reinforcing element, the main direction of each carcass filamentary reinforcing element in the or each carcass ply forming, with the circumferential direction of the support, an initial angle of each carcass filamentary reinforcing element,
in which method:
there is formed, by winding a working ply or a plurality of working plies, radially outside the wound carcass assembly, a wound working assembly intended to form the working layer, the wound working assembly being axially delimited by two axial edges of the wound working assembly and comprising working filamentary reinforcing elements extending substantially parallel to one another axially from one axial edge to the other axial edge of the wound working assembly, each working filamentary reinforcing element extending, in the or each working ply, in a main direction of each working filamentary reinforcing element, the main direction of each working filamentary reinforcing element in the or each working ply forming, with the circumferential direction of the support, an initial angle of each working filamentary reinforcing element, the wound carcass assembly and the wound working assembly forming an assembly of substantially cylindrical shape around the main axis of the support,
the assembly of substantially cylindrical shape around the main axis of the support is deformed so as to obtain an assembly of substantially toric shape around the main axis of the support so that:

the main direction of each carcass filamentary reinforcing element forms, with the circumferential direction of the support:
a final angle of each carcass filamentary reinforcing element, in absolute value, strictly less than 80°, in a portion of the wound carcass assembly extending axially in radial line with the wound working assembly,
a final angle of each carcass filamentary reinforcing element ranging, in absolute value, from 80° to 90°, in a portion of the wound carcass assembly intended to extend radially in each sidewall,

the main direction of each working filamentary reinforcing element forms, with the circumferential direction of the support, a final angle of each working filamentary reinforcing element, in absolute value, strictly greater than 10°,
during the step of forming the wound carcass assembly, the wound carcass assembly having two circumferential end edges extending axially from one of the axial edges to the other of the axial edges of the wound carcass assembly, one of the following alternatives I, II, III is implemented:
I—the wound carcass assembly is formed so as to form a junction between the two circumferential end edges of the wound carcass assembly by abutment without forming a superposition between a carcass filamentary reinforcing element of one of the circumferential end edges of the wound carcass assembly and a carcass filamentary reinforcing element of the other of the circumferential end edges of the wound carcass assembly, at least in the portion of the wound carcass assembly intended to extend axially in radial line with the wound working assembly,
II—the wound carcass assembly is formed so as to form a junction between the two circumferential end edges of the wound carcass assembly by overlapping so as to form a radial superposition between at least one carcass filamentary reinforcing element of one of the circumferential end edges of the wound carcass assembly and at least one carcass filamentary reinforcing element of the other of the circumferential end edges of the wound carcass assembly, at least in the portion of the wound carcass assembly intended to extend axially in radial line with the wound working assembly, so that, without a step of forming the wound working assembly prior to the deformation step, the deformation step would lead to an opening of the junction,
III—the wound carcass assembly is formed so that the two circumferential end edges of the wound carcass assembly are circumferentially spaced from one another at least in the portion of the wound carcass assembly intended to extend axially in radial line with the wound working assembly.

The method according to the invention envisages three alternatives all three using the advantages conferred by the presence, during the deformation step, of the wound working assembly radially overhanging the portion of the wound carcass assembly undergoing the most circumferential elongation. Specifically, during the deformation step, the axially central portion of the cylindrical assembly will undergo a rate of deformation which is much greater than the rate of deformation undergone by the lateral axial portions of this cylindrical assembly. However, unlike the prior art in which the carcass ply is deformed without any working ply being superimposed on it, the method of the invention provides that the wound carcass assembly is radially covered by the wound working assembly before the deformation step, in the axially central portion undergoing the highest rate of deformation. Thus, the wound working assembly takes up a large part of the circumferential forces exerted on the assembly formed by the wound carcass assembly and the wound working assembly. This then prevents excessive circumferential forces from being taken up by the wound carcass assembly, which makes it possible to reduce the circumferential extent of the junction between the circumferential end edges, or even to eliminate the junction.

The rate of deformation is determined in a manner known to those skilled in the art as a function of the axial drawing together of the axial edges of the wound carcass assembly and of the radial enlargement of the assembly between its cylindrical shape and its toric shape. The determination of the initial angles as a function of the final angles depends, in a manner known to those skilled in the art, on the rate of deformation as explained in FR2797213 and FR1413102.

In the first alternative I, a junction is formed by abutting face to face without radial superposition of the two circumferential end edges. Thus, any extra thickness is avoided while forming a junction between the two circumferential end edges making it possible to ensure structural continuity of the wound carcass assembly. This first alternative makes it possible to optimize the appearance of the sidewalls and the high-speed uniformity as much as possible.

In the second alternative II, a junction is formed by abutting with radial superposition of the two circumferential end edges, this radial superposition giving rise to the formation of a junction which is more fragile, because it is circumferentially relatively small in extent, than the junction of the method of the prior art, which is itself more resistant because it is circumferentially relatively extensive. Thus, as in the first alternative, any opening of the junction is avoided, even for methods in which the rates of deformation are relatively high and in which, due to the fragility of the junction, if one had not wound the wound working assembly prior to the deformation step, one would have caused, by implementing the deformation step under identical conditions, in particular as regards the rate of deformation, the opening of the junction due to excessive circumferential forces exerted on the wound carcass assembly. In other words, in the second alternative II, the wound carcass assembly is formed so as to form a junction between the two circumferential end edges of the wound carcass assembly by overlapping so as to form a radial superposition between at least one carcass filamentary reinforcing element of one of the circumferential end edges of the wound carcass assembly and at least one carcass filamentary reinforcing element of the other of the circumferential end edges of the wound carcass assembly, at least in the portion of the wound carcass assembly intended to extend axially in radial line with the wound working assembly, so that, without a step of forming the wound working assembly prior to the deformation step, a step of deforming the wound carcass assembly alone, having a rate of deformation equal to the rate of deformation of the step of deforming the assembly of the wound carcass assembly and the wound working assembly, would cause the junction to open. The rate of deformation corresponds to the rate of radial expansion of the assembly to pass from its substantially cylindrical shape to its substantially toric shape and is equal to the ratio of the distance between the radially outermost point of the assembly and the main axis of the manufacturing support after deformation to the distance between the radially outermost point of the assembly and the main axis of the manufacturing support before deformation. In addition, this makes it possible to significantly reduce the constraints on the number of filamentary reinforcing elements that must be located in the junction in cases where certain performance levels of the tyre require a junction by abutment with radial superposition of the two circumferential end edges.

In the second alternative II, the method according to the invention can thus be implemented advantageously in the case of methods in which the radially outermost circumferential end edge of the wound carcass assembly covers the radially innermost circumferential end edge of the wound carcass assembly with at most 4 carcass filamentary reinforcing elements, preferably at most 3 carcass filamentary reinforcing elements and even more preferably at most 2 carcass filamentary reinforcing elements at least in the portion of the wound carcass assembly intended to extend axially in radial line with the wound working assembly. Preferably, the radially outermost circumferential end edge covers the radially innermost circumferential end edge with at least 1 carcass filamentary reinforcing element at least in the axial portion of the wound carcass assembly intended to extend axially in radial line with the wound working assembly so as to limit the consequences on certain performance levels of the tyre, in particular during use under very severe use conditions.

In the third alternative III, an absence of junction is allowed. Specifically, the wound working assembly taking up a large part of the circumferential forces during deformation, an uncontrolled separation between the two circumferential end edges is avoided. Thus, it is possible to envisage an absence of junction and a distance between the two circumferential end edges up to a threshold which will have been predetermined as a function of the desired performance levels, a threshold which will be guaranteed not to be exceeded thanks to the method according to the invention. The absence of junction is such that the wound carcass assembly is formed so that:
the two circumferential end edges of the wound carcass assembly are circumferentially spaced from one another, and
that there is a separation space between the two circumferential end edges of the wound carcass assembly during the step of forming the working assembly,
at least in the portion of the wound carcass assembly intended to extend axially in radial line with the wound working assembly.

In the third alternative III, the method according to the invention can thus be advantageously implemented in the case of methods in which the circumferential end edges of the wound carcass assembly are circumferentially spaced apart by an average distance of at most 2.5 mm, preferably at most 2 mm and more preferably at most 1 mm, at least in the portion of the wound carcass assembly intended to extend axially in radial line with the wound working assembly so as to limit the consequences on certain performance levels of the tyre, in particular during use under very severe use conditions. The term average distance is understood to mean the average of ten distances measured equally distributed over the axial width of the portion of the wound carcass assembly intended to extend in radial line with the wound working assembly.

In the first and second alternatives, unlike the third alternative, structural continuity of the wound carcass assembly is ensured, making it possible to maximize the uniformity of the appearance and the uniformity of the tyre at high speed. At the end of the deformation step, the two circumferential end edges are in contact with one another in the portion of the wound carcass assembly intended to extend axially in radial line with the wound working assembly due to the low forces exerted on the wound carcass assembly. In other words, the opening of the junction in the portion of the wound carcass assembly intended to extend axially in radial line with the wound working assembly during the deformation step is avoided.

The method according to the invention can be implemented due to the particular arrangement of the cylindrical assembly in which the initial angles formed with the circumferential direction of the support by the main directions of the carcass and working filamentary reinforcing elements vary during the deformation step to reach their final angles, with the exception of the wound portion of the carcass assembly wound around the circumferential reinforcing elements in which the main direction of the carcass filamentary reinforcing elements remains substantially identical relative to the circumferential direction of the support and therefore of the tyre.

On the one hand, these final angles are such that the main direction of the carcass reinforcing elements form in each sidewall, with the circumferential direction of the support and therefore of the tyre, an angle ranging, in absolute value, from 80° to 90° conferring the properties of a conventional radial tyre. On the other hand, these final angles are such that the main direction of the carcass reinforcing elements form, in radial line with the wound working assembly, with the circumferential direction of the support and therefore of the tyre, an angle, in absolute value, strictly less than 80° and which, combined with the final angle formed by the main direction of each working filamentary reinforcing element with the circumferential direction of the support and therefore of the tyre, in absolute value, strictly greater than 10°, makes it possible to define a triangulation which, in the prior art, necessarily requires the presence of two working layers.

The presence of a single wound working assembly intended to form the single working layer makes it possible in particular to lighten the tyre, therefore to reduce the energy dissipated by the hysteresis of the crown and therefore to reduce the rolling resistance of the tyre.

According to the invention, the working reinforcement comprises a single working layer. Thus, the working reinforcement, apart from the working layer, does not have any layer reinforced by filamentary reinforcing elements. The filamentary reinforcing elements of such reinforced layers excluded from the working reinforcement of the tyre comprise metal filamentary reinforcing elements and textile filamentary reinforcing elements. Very preferably, the working reinforcement is formed by the single working layer.

According to the invention, the carcass reinforcement comprises at least one carcass layer.

Thus, in one embodiment, the carcass reinforcement comprises a single carcass layer and is therefore, with the exception of the single carcass layer, devoid of any layer reinforced by filamentary reinforcing elements. The filamentary reinforcing elements of such reinforced layers excluded from the carcass reinforcement of the tyre comprise metal filamentary reinforcing elements and textile filamentary reinforcing elements. Very preferably, the carcass reinforcement consists of the single carcass layer. In another embodiment, the carcass reinforcement comprises two carcass layers.

By main direction in which a filamentary reinforcing element extends is meant the direction in which the filamentary reinforcing element extends along its greatest length. The main direction in which a filamentary reinforcing element extends may be rectilinear or curved, the reinforcing element being able to describe along its main direction a rectilinear or else wavy path.

By portion of the assembly, of a layer or of the tyre lying axially between the axial edges of a wound assembly or of a layer or of a reinforcement, there is understood a portion of the assembly, of the layer or of the tyre extending axially and lying between the radial planes passing through the axial edges of the wound assembly or of the layer or of the reinforcement.

By portion of a wound assembly intended to extend axially, portion of a wound assembly extending axially or portion of a layer extending axially in radial line with a reference assembly or a reference layer, there is understood a portion of said assembly or of said layer lying between the radial projections of the axial edges of the reference assembly or of the reference layer on said assembly or said layer. Any range of values denoted by the expression “between a and b” represents the range of values from more than a to less than b (i.e. excluding the limits a and b), whereas any range of values denoted by the expression “from a to b” means the range of values from a up to b (i.e. including the strict limits a and b).

In the tyre, the angle considered is the angle, in absolute value, which is the smaller of the two angles defined between the reference straight line, here the circumferential direction of the tyre, and the main direction in which the filamentary reinforcing element considered extends.

In the tyre and during the method, by orientation of an angle is meant the direction, clockwise or anti-clockwise, in which it is necessary to turn from the reference straight line, here the circumferential direction of the support or of the tyre, defining the angle to reach the main direction in which the filamentary reinforcing element considered extends.

During the method, the angles considered formed by the main directions in which the working and carcass filamentary reinforcing elements extend are by convention angles of opposite orientations and the angle formed by the main direction in which each working filamentary reinforcing element extends is, in absolute value, the smaller of the two angles defined between the reference straight line, here the circumferential direction of the support or of the tyre, and the main direction in which the working filamentary reinforcing element extends. Thus, the angle formed by the main direction in which each working filamentary reinforcing element extends defines an orientation which is opposite to that formed by the angle of the main direction in which each carcass filamentary reinforcing element extends. In a simplified method in which only one carcass ply has to be handled to form the wound carcass assembly and in which there would be avoided circumferential junctions between a plurality of carcass plies of axial widths smaller than the axial width of the wound carcass assembly intended to be formed, the wound carcass assembly consists of the carcass ply which is intended to form the carcass layer. In other words, the carcass ply is axially continuous.

In the case where the or each wound carcass assembly is formed with a plurality of carcass plies, preferably a plurality of carcass plies will be used in which the main directions of the carcass filamentary reinforcing elements are all parallel to one another.

In the embodiment in which the carcass reinforcement comprises a single carcass layer, there is formed, by winding a carcass ply or a plurality of carcass plies around a support having a substantially cylindrical shape around a main axis, a wound carcass assembly intended to form the carcass layer.

In the embodiment in which the carcass reinforcement comprises two carcass layers, there is formed, by winding a carcass ply ora plurality of carcass plies around a support having a substantially cylindrical shape around a main axis, two wound carcass assemblies each intended to form each carcass layer. In this embodiment with two carcass layers, during the step of forming each wound carcass assembly, one of the alternatives I, II, III is implemented for each wound carcass assembly. Thus, the same alternative I, II or III may preferably be implemented for the two wound carcass assemblies. Alternatively, different alternatives for each wound carcass assembly may be implemented.

Similarly, in a simplified method in which only one working ply has to be handled to form the wound working assembly and in which there would be avoided circumferential junctions between a plurality of working plies of axial widths smaller than the axial width of the wound working assembly intended to be formed, the wound working assembly consists of the working ply which is intended to form the working layer. In other words, the working ply is axially continuous. In the case where the wound working assembly is formed with a plurality of working plies, preferably a plurality of working plies will be used in which the main directions of the working filamentary reinforcing elements are all parallel to one another. Of course, main directions of the working filamentary reinforcing elements that are not parallel to one another from one working ply to the other can be considered.

In a preferred embodiment, it is preferred to implement only the first and second alternatives. Thus, preferably, during the step of forming the wound carcass assembly, one of the alternatives I or II is implemented.

In an even more preferred embodiment, it is preferred to implement only the first alternative. Thus, very preferably, during the step of forming the wound carcass assembly, the alternative I is implemented.

Whatever the previously described envisaged embodiment, preferably, the wound carcass assembly is formed so as to form a junction between the two circumferential end edges of the wound carcass assembly by abutment without forming a superposition between a carcass filamentary reinforcing element of one of the circumferential end edges of the wound carcass assembly and a carcass filamentary reinforcing element of the other of the circumferential end edges of the wound carcass assembly, over the entire axial width of the wound carcass assembly between the two axial edges of the wound carcass assembly.

Whatever the previously described envisaged embodiment, preferably, the wound carcass assembly is formed so as to form a junction between the two circumferential end edges of the wound carcass assembly by overlapping so as to form a radial superposition between at least one carcass filamentary reinforcing element of one of the circumferential end edges of the wound carcass assembly and at least one carcass filamentary reinforcing element of the other of the circumferential end edges of the wound carcass assembly, so that, without a step of forming the wound working assembly prior to the deformation step, the deformation step would cause the junction to open, over the entire axial width of the wound carcass assembly between the two axial edges of the wound carcass assembly.

Whatever the previously described envisaged embodiment, preferably, the wound carcass assembly is formed so that the two circumferential end edges of the wound carcass assembly are circumferentially spaced from one another, over the entire axial width of the wound carcass assembly between the two axial edges of the wound carcass assembly.

Thus, by implementing the junctions or the absence of junction over the entire axial width of the wound carcass assembly between the two axial edges of the wound carcass assembly, differentiating the junctions and the absence of junction between the portion of the wound carcass assembly intended to extend axially in radial line with the wound working assembly and the axial portions of the wound carcass assembly intended to extend radially in each sidewall is avoided. This is all the more advantageous in that during the deformation step, due to a much less radial deformation of each portion of the wound carcass assembly intended to extend radially in each sidewall with respect to the portion of the wound carcass assembly intended to extend axially in radial line with the wound working assembly, the circumferential forces in each portion of the wound carcass assembly intended to extend radially in each sidewall are much less than in the portion of the wound carcass assembly intended to extend axially in radial line with the wound working assembly. Thus, the junction or the absence of junction is much less stressed in each portion of the wound carcass assembly intended to extend radially in each sidewall and the associated risks are much less. Finally, by implementing the junction or the absence of junction over the entire axial width of the wound carcass assembly, the appearance and the high-speed uniformity of the tyre are further improved.

In embodiments in which the main direction of each carcass filamentary reinforcing element has, between the portions, transition zones where the angle is substantially variable, the portion of the wound carcass assembly extending axially in radial line with the wound working assembly and in which the main direction of each carcass filamentary reinforcing element forms, with the circumferential direction of the support, a final angle, in absolute value, strictly less than 80°, has an axial width equal to at least 40%, preferably at least 50%, of the axial width of the wound working assembly.

In embodiments in which the main direction of each carcass filamentary reinforcing element has, between the portions, transition zones where the angle is substantially variable, the portion of the wound carcass assembly extending axially in radial line with the wound working assembly and in which the main direction of each carcass filamentary reinforcing element forms, with the circumferential direction of the support, a final angle, in absolute value, strictly less than 80°, has an axial width equal to at most 90%, preferably at most 80%, of the axial width of the wound working assembly.

Preferably, the median plane of the assembly intersects this portion of the wound carcass assembly extending axially in radial line with the wound working assembly. More preferably, this portion of the wound carcass assembly extending axially in radial line with the wound working assembly is axially centred on the median plane of the assembly.

The axial width of the portion of the wound carcass assembly depends in particular on the rate of deformation as well as on the initial angles. Those skilled in the art will know, by varying one and/or the other of these parameters, how to vary the axial width of the portion of the wound carcass assembly concerned.

In embodiments in which the main direction of each carcass filamentary reinforcing element has, between the portions, transition zones where the angle is substantially variable, each portion of the wound carcass assembly intended to extend radially in each sidewall and in which the main direction of each carcass filamentary reinforcing element forms, with the circumferential direction of the support, a final angle ranging, in absolute value, from 80° to 90°, has a radial height equal to at least 5%, preferably at least 15% and even more preferably at least 30%, of the radial height of the manufactured tyre.

In embodiments in which the main direction of each carcass filamentary reinforcing element has, between the portions, transition zones where the angle is substantially variable, each portion of the wound carcass assembly intended to extend radially in each sidewall and in which the main direction of each carcass filamentary reinforcing element forms, with the circumferential direction of the support, a final angle ranging, in absolute value, from 80° to 90°, has a radial height equal to at most 80%, preferably at most 70% and even more preferably at most 60%, of the radial height of the manufactured tyre.

Preferably, the equatorial circumferential plane of the assembly intersects each portion of the wound carcass assembly intended to be located in each sidewall.

Similarly, the radial height of the portion of the wound carcass assembly depends in particular on the rate of deformation as well as on the initial angles. Those skilled in the art will know, by varying one and/or the other of these parameters, how to vary the radial height of each portion of the wound carcass assembly concerned.

By median plane of the assembly (denoted m) is meant the plane perpendicular to the main axis of the support which is located at mid-axial distance between each axial edge of the assembly.

By equatorial circumferential plane of the assembly (denoted e) is meant the theoretical cylindrical surface passing through the equator of the assembly, perpendicular to the median plane and to the radial direction. The equator of the assembly is, in a meridian section plane (plane perpendicular to the circumferential direction and parallel to the radial and axial directions), the axis parallel to the main axis of the support and located equidistant between the radially outermost point of the assembly and the radially innermost point of the assembly, the distance between these two points being equal to h.

The invention may advantageously be implemented by using carcass layers comprising carcass filamentary reinforcing elements of relatively large size. The use of carcass filamentary reinforcing elements of relatively large size is made preferable in the case where it is desired to improve the mechanical strength of the carcass reinforcement and where, in order to achieve such an improvement, the increase in the count with identical material, and therefore the increase in size, is a simple and economical solution. Specifically, in the method and the tyre of the prior art, due to a circumferentially relatively broad junction, it is very detrimental to use carcass filamentary reinforcing elements of relatively large size which amplify the deformation of the sidewalls as explained in WO2019180352. One solution to this problem consists in using carcass filamentary reinforcing elements of smaller size and to use not one but two carcass layers, which increases the cost and weight of the tyre. By contrast, thanks to circumferentially relatively small or non-existant junctions, the invention allows the use of carcass filamentary reinforcing elements of relatively large size without running the risk of causing deformation of the sidewalls.

In addition, in each bead of the tyre, the wound portion comprises an axially internal portion comprising carcass filamentary reinforcing elements in which the angle of the main direction formed with the circumferential direction is, in absolute value, substantially equal to the angle of the main direction formed with the circumferential direction of the carcass filamentary reinforcing elements of an axially external portion of the wound portion. However, the orientations of these angles are opposite due to the winding around the circumferential reinforcing element, which makes it possible to reduce the axial thickness of the superposition of the axially internal portion and of the axially external portion with respect to a conventional wound portion in which the angles have identical absolute values and orientations. By reducing the axial thickness of the superposition, the risk of seeing deformation is further reduced.

Thus, advantageously, it is possible to use carcass filamentary reinforcing elements such that:
each carcass filamentary reinforcing element comprises at least one polyester multifilament strand and has a total count greater than or equal to 450 tex, preferably greater than or equal to 500 tex, or
each carcass filamentary reinforcing element comprises at least one polyester multifilament strand and at least one multifilament strand of aromatic polyamide and has a total count greater than or equal to 350 tex, preferably greater than or equal to 400 tex.

In a very preferred embodiment, after the step of deforming the assembly, there is arranged, radially outside the assembly of substantially toric shape, a wound hooping assembly intended to form a hoop reinforcement, the wound hooping assembly being formed by helical winding of at least one hooping filamentary reinforcing element or of a hooping ply obtained by embedding one or more hooping filamentary reinforcing elements in an elastomeric matrix, so as to extend axially from one axial edge to the other axial edge of the wound hooping assembly.

Advantageously, the or each hooping filamentary reinforcing element extending in a main direction of the or each hooping filamentary reinforcing element, the angle formed by the main direction of the or each hooping filamentary reinforcing element with the circumferential direction of the support is, in absolute value, less than or equal to 10°, preferably less than or equal to 7° and more preferably less than or equal to 5°.

In preferred embodiments making it possible to obtain effective triangulation, the main direction of the or each hooping filamentary reinforcing element, the main direction of each working filamentary reinforcing element and the main direction of each carcass filamentary reinforcing element form, with the circumferential direction of the support, in a portion of the assembly and of the wound hooping assembly lying axially between the axial edges of the axially narrowest wound assembly among the wound working assembly and the wound hooping assembly, paired angles different in absolute value.

The portion of the assembly and of the wound hooping assembly lying axially between the axial edges of the axially narrowest wound assembly among the wound working assembly and the wound hooping assembly and in which the main direction of the or each hooping filamentary reinforcing element, the main direction of each working filamentary reinforcing element and the main direction of each carcass filamentary reinforcing element form, with the circumferential direction of the support, paired angles different in absolute value, has an axial width equal to at least 40%, preferably at least 50%, of the axial width of the wound working assembly.

The portion of the assembly and of the wound hooping assembly lying axially between the axial edges of the axially narrowest wound assembly among the wound working assembly and the wound hooping assembly and in which the main direction of the or each hooping filamentary reinforcing element, the main direction of each working filamentary reinforcing element and the main direction of each carcass filamentary reinforcing element form, with the circumferential direction of the support, paired angles different in absolute value, has an axial width equal to at most 90%, preferably at most 80%, of the axial width of the wound working assembly.

Preferably, the median plane of the assembly intersects this portion of the assembly and of the wound hooping assembly lying axially between the axial edges of the axially narrowest wound assembly among the wound working assembly and the wound hooping assembly. More preferably, this portion of the assembly and of the wound hooping assembly lying axially between the axial edges of the axially narrowest wound assembly among the wound working assembly and the wound hooping assembly is axially centred on the median plane of the assembly.

In order to obtain, at the end of the deformation step, final angles allowing a preferential compromise in performance of the tyre, the following advantageously applies:
the initial angle formed by the main direction of each working filamentary reinforcing element with the circumferential direction of the support is, in absolute value, strictly greater than 0°, preferably ranges from 4° to 60° and more preferably ranges from 16° to 47°,
the initial angle formed by the main direction of each carcass filamentary reinforcing element with the circumferential direction of the support is, in absolute value, strictly greater than 0°, preferably ranges from 27° to 150° and more preferably ranges from 56° to 123°.

Such a preferential compromise in performance of the tyre is obtained when:
the final angle formed by the main direction of each working filamentary reinforcing element with the circumferential direction of the support ranges, in absolute value, from 15° to 50°, preferably from 18° to 30°,
the final angle formed by the main direction of each carcass filamentary reinforcing element with the circumferential direction of the support is, in absolute value, greater than or equal to 10°, preferably ranges from 20° to 75° and more preferably ranges from 35° to 70°, in the portion of the wound carcass assembly extending axially in radial line with the wound working assembly.

In some embodiments, the final angle formed by the main direction of each working filamentary reinforcing element with the circumferential direction of the support is substantially equal to the angle formed by the main direction of each working filamentary reinforcing element of the working layer with the circumferential direction of the tyre once the latter has been manufactured. Similarly, in these same embodiments, the final angle formed by the main direction of each carcass filamentary reinforcing element with the circumferential direction of the support in the portion of the wound carcass assembly extending axially in radial line with the wound working assembly is substantially equal to the angle formed by the main direction of each carcass filamentary reinforcing element of the carcass layer with the circumferential direction of the tyre in the portion of the carcass layer extending axially in radial line with the working layer once the tyre has been manufactured.

In other embodiments, a slight decrease in the final angles may occur during the step of moulding the green blank in a mould during which the green blank is pressed against moulding surfaces of the mould and undergoes a non-negligible radial moulding deformation with respect to the deformation undergone during the deformation step to change the assembly of the wound carcass assembly and the wound working assembly from the substantially cylindrical shape to the substantially toric shape.

In one embodiment making it possible to easily anchor the carcass reinforcement in each bead, after the step of forming the wound carcass assembly:
two circumferential reinforcing elements are arranged around the wound carcass assembly,
each axial edge of the wound carcass assembly is turned axially inwards so as to radially cover each circumferential reinforcing element by one of the axial edges of the wound carcass assembly and to form a portion of the wound carcass assembly wound around each circumferential reinforcing element,
the assembly of substantially cylindrical shape is deformed so as to obtain the assembly of substantially toric shape so that the main direction of each carcass filamentary reinforcing element forms, with the circumferential direction of the support, a final angle of each carcass filamentary reinforcing element, in absolute value, strictly less than 80°, in the wound portion of the wound carcass assembly.

In this preferred embodiment, the final angle formed by the main direction of each carcass filamentary reinforcing element, with the circumferential direction of the support, in the wound portion of the wound carcass assembly, is substantially identical to the initial angle formed by the main direction of each carcass filamentary reinforcing element before the deformation step due to the anchoring of this portion around the circumferential reinforcing element.

Another subject of the invention is a tyre obtained by the method defined above. As indicated above, a tyre according to the invention exhibits improved appearance and improved high-speed uniformity.

The tyres of the invention are preferably intended for passenger vehicles. Such a tyre has a section in a meridian section plane characterized by a section width S and a section height H, within the meaning of the standard of the European Tyre and Rim Technical Organisation or “ETRTO”, such that the ratio H/S, expressed as a percentage, is at most equal to 90, preferably at most equal to 80 and more preferably at most equal to 70 and is at least equal to 30, preferably at least equal to 40, and the section width S is at least equal to 115 mm, preferably at least equal to 155 mm and more preferably at least equal to 175 mm and at most equal to 385 mm, preferably at most equal to 315 mm, more preferably at most equal to 285 mm and even more preferably at most equal to 255 mm. In addition, the diameter at the hook D, defining the diameter of the tyre mounting rim, is at least equal to 12 inches, preferably at least equal to 16 inches and at most equal to 24 inches, preferably at most equal to 20 inches.

By axial direction is meant the direction substantially parallel to the main axis of the tyre, that is to say the axis of rotation of the tyre.

The expression circumferential direction means the direction that is substantially perpendicular both to the axial direction and to a radius of the tyre (in other words, tangent to a circle centred on the axis of rotation of the tyre).

The expression radial direction means the direction along a radius of the tyre, namely any direction that intersects the axis of rotation of the tyre and is substantially perpendicular to that axis.

The expression median plane of the tyre (denoted M) is understood to mean the plane perpendicular to the axis of rotation of the tyre which is situated at mid-axial distance between the two beads and passes through the axial middle of the crown reinforcement.

By equatorial circumferential plane of the tyre (denoted E) is meant the theoretical cylindrical surface passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and located equidistantly between the radially outermost point of the tread that is intended to be in contact with the ground and the radially innermost point of the tyre that is intended to be in contact with a support, for example a rim, the distance between these two points being equal to H.

The expression meridian plane is understood to mean a plane parallel to and containing the axis of rotation of the tyre and perpendicular to the circumferential direction.

The expression bead is understood to mean the portion of the tyre intended to enable the tyre to be hooked onto a mounting support, for example a wheel comprising a rim. Thus, each bead is in particular intended to be in contact with a hook of the rim allowing it to be hooked.

In the case where the first alternative I has been implemented, the carcass layer extends circumferentially, forming a junction by abutting face to face between the circumferential end edges of the carcass layer without forming a radial superposition between a carcass filamentary reinforcing element of one of the circumferential end edges and a carcass filamentary reinforcing element of the other of the circumferential end edges, at least in the portion of the carcass layer extending axially in radial line with the working layer.

In the case where the second alternative II has been implemented, the carcass layer extends circumferentially, forming a junction by overlapping so as to form a radial superposition between at least one carcass filamentary reinforcing element of one of the circumferential end edges and at least one carcass filamentary reinforcing element of the other of the circumferential end edges at least in the portion of the carcass layer extending axially in radial line with the working layer. In the second alternative, it is thus possible to obtain a tyre in which the radially outermost circumferential end edge of the carcass layer covers the radially innermost circumferential end edge of the carcass layer with at most 4 carcass filamentary reinforcing elements, preferably at most 3 carcass filamentary reinforcing elements and even more preferably at most 2 carcass filamentary reinforcing elements, at least in the portion of the carcass layer extending axially in radial line with the working layer. Preferably, the radially outermost circumferential end edge of the carcass layer covers the radially innermost circumferential end edge of the carcass layer with at least 1 carcass filamentary reinforcing element at least in the portion of the carcass layer extending axially in radial line with the working layer for the same reasons as those mentioned for the method. The expression average distance is understood to mean the average of ten distances measured equally distributed over the axial width of the portion of the carcass layer intended to extend in radial line with the working layer.

In the case where the third alternative III has been implemented, the two circumferential end edges are circumferentially spaced from one another at least in the portion of the carcass layer extending axially in radial line with the working layer. In the third alternative, it is thus possible to obtain a tyre in which the circumferential end edges of the carcass layer are circumferentially spaced apart by an average distance of at most 2.5 mm, preferably at most 2 mm and more preferably at most 1 mm at least, in the portion of the carcass layer extending axially in radial line with the working layer for the same reasons as those mentioned for the method.

Whatever the embodiment of the previously described envisaged method, preferably, when the first alternative I is implemented, the carcass layer extends circumferentially, forming a junction by abutting face to face between the circumferential end edges of the carcass layer without forming a radial superposition between a carcass filamentary reinforcing element of one of the circumferential end edges and a carcass filamentary reinforcing element of the other of the circumferential end edges, over the entire axial width of the carcass layer between the two axial edges of the carcass layer.

Whatever the embodiment of the previously described envisaged method, preferably, when the second alternative II is implemented, the carcass layer extends circumferentially, forming a junction by overlapping so as to form a radial superposition between at least one carcass filamentary reinforcing element of one of the circumferential end edges and at least one carcass filamentary reinforcing element of the other of the circumferential end edges, over the entire axial width of the carcass layer between the two axial edges of the carcass layer. In the second alternative, it is thus possible to obtain a tyre in which the radially outermost circumferential end edge of the carcass layer covers the radially innermost circumferential end edge of the carcass layer with at most 4 carcass filamentary reinforcing elements, preferably at most 3 carcass filamentary reinforcing elements and even more preferably at most 2 carcass filamentary reinforcing elements, over the entire axial width of the carcass layer between the two axial edges of the carcass layer. Preferably, the radially outermost circumferential end edge of the carcass layer covers the radially innermost circumferential end edge of the carcass layer with at least 1 carcass filamentary reinforcing element, over the entire axial width of the carcass layer between the two axial edges of the carcass layer.

Whatever the embodiment of the previously described envisaged method, preferably, when the third alternative III is implemented, the carcass layer has two circumferential end edges, the two circumferential end edges being circumferentially spaced from one another, over the entire axial width of the carcass layer between the two axial edges of the carcass layer. In the third alternative, it is thus possible to obtain a tyre in which the circumferential end edges of the carcass layer are circumferentially spaced apart by an average distance of at most 2.5 mm, preferably at most 2 mm and more preferably at most 1 mm, over the entire axial width of the carcass layer between the two axial edges of the carcass layer.

In one embodiment:
the working layer is axially delimited by two axial edges of the working layer and comprises the working filamentary reinforcing elements extending axially from one axial edge to the other axial edge of the working layer, substantially parallel to one another in a main direction of each working filamentary reinforcing element forming, with the circumferential direction of the tyre, an angle, in absolute value, strictly greater than 10°,
the carcass layer is axially delimited by two axial edges of the carcass layer and comprises the carcass filamentary reinforcing elements extending axially from one axial edge to the other axial edge of the carcass layer, each carcass filamentary reinforcing element extending in a main direction of each carcass filamentary reinforcing element forming, with the circumferential direction of the tyre:
   an angle, in absolute value, strictly less than 80° in a portion of the carcass layer extending axially in radial line with the working layer,
   an angle ranging, in absolute value, from 80° to 90° in at least one portion of the carcass layer extending radially in each sidewall.

In embodiments in which the main direction of each carcass filamentary reinforcing element has, between the portions, transition zones where the angle is substantially variable, the portion of the carcass layer extending axially in line with the working layer and in which the main direction of each carcass filamentary reinforcing element forms, with the circumferential direction of the tyre, an angle, in absolute value, strictly less than 80°, has an axial width equal to at least 40%, preferably at least 50%, of the axial width of the working layer.

In embodiments in which the main direction of each carcass filamentary reinforcing element has, between the portions, transition zones where the angle is substantially variable, the portion of the carcass layer extending axially in line with the working layer and in which the main direction of each carcass filamentary reinforcing element forms, with the circumferential direction of the tyre, an angle, in absolute value, strictly less than 80°, has an axial width equal to at most 90%, preferably at most 80%, of the axial width of the working layer.

Preferably, the median plane of the tyre intersects this portion of the carcass layer extending axially in line with the working layer. More preferably, this portion of the carcass layer extending axially in line with the working layer is axially centred on the median plane of the tyre.

In embodiments in which the main direction of each carcass filamentary reinforcing element has, between the portions, transition zones where the angle is substantially variable, each portion of the carcass layer extending radially in each sidewall and in which the main direction of each carcass filamentary reinforcing element forms, with the circumferential direction of the tyre, an angle ranging, in absolute value, from 80° to 90°, has a radial height equal to at least 5%, preferably at least 15% and more preferably at least 30%, of the radial height of the tyre.

In embodiments in which the main direction of each carcass filamentary reinforcing element has, between the portions, transition zones where the angle is substantially variable, each portion of the carcass layer extending radially in each sidewall and in which the main direction of each carcass filamentary reinforcing element forms, with the circumferential direction of the tyre, an angle ranging, in absolute value, from 80° to 90°, has a radial height equal to at most 80%, preferably at most 70% and more preferably at most 60%, of the radial height of the tyre.

Preferably, the equatorial circumferential plane of the tyre intersects each of these portions of the carcass layer located in each sidewall.

Thus, in order to improve the performance of the tyre, in particular in terms of cornering stiffness and at high speed, a very advantageous embodiment provides for the crown reinforcement to comprise a hoop reinforcement arranged radially outside the working reinforcement, the hoop reinforcement being axially delimited by two axial edges of the hoop reinforcement and comprising at least one hooping filamentary reinforcing element wound circumferentially helically so as to extend axially from one axial edge to the other axial edge of the hoop reinforcement in a main direction of the or each hooping filamentary reinforcing element.

The hoop reinforcement is thus radially interposed between the working reinforcement and the tread.

Hooping filamentary reinforcing elements suitable for implementing the method according to the invention are described in particular in documents WO2016166056, WO2016166057, WO2019122620, WO2016091809, WO2016091810, WO2016091811 and WO2016091812.

Advantageously, the main direction of the or each hooping filamentary reinforcing element forms, with the circumferential direction of the tyre, an angle, in absolute value, less than or equal to 10°, preferably less than or equal to 7° and more preferably less than or equal to 5°.

In the tyre according to the invention, the crown comprises the tread and the crown reinforcement. The tread is understood to be a strip of polymeric, preferably elastomeric, material delimited:
radially towards the outside by a surface intended to be in contact with the ground, and
radially towards the inside by the crown reinforcement.

The strip of polymeric material consists of a layer of a polymeric, preferably elastomeric, material or consists of a stack of a plurality of layers, each layer consisting of a polymeric, preferably elastomeric, material.

In an advantageous embodiment, the crown reinforcement comprises a single hoop reinforcement and a single working reinforcement. Thus, the crown reinforcement is, with the exception of the hoop reinforcement and the working reinforcement, devoid of any reinforcement reinforced by filamentary reinforcing elements. The filamentary reinforcing elements of such reinforcements excluded from the crown reinforcement of the tyre comprise metallic filamentary reinforcing elements and textile filamentary reinforcing elements. Very preferably, the crown reinforcement is made up of the hoop reinforcement and the working reinforcement.

In a very preferred embodiment, the crown, apart from the crown reinforcement, does not have any reinforcement reinforced by filamentary reinforcing elements. The filamentary reinforcing elements of such reinforcements excluded from the crown of the tyre comprise metallic filamentary reinforcing elements and textile filamentary reinforcing elements. Very preferably, the crown is made up of the tread and the crown reinforcement.

In a very preferred embodiment, the carcass reinforcement is arranged so as to be directly radially in contact with the crown reinforcement and the crown reinforcement is arranged so as to be directly radially in contact with the tread. In this very preferred embodiment, the hoop reinforcement and the working layer are advantageously arranged directly radially in contact with one another.

The expression directly radially in contact means that the objects in question that are directly radially in contact with one another, in this case the layers, reinforcements or the tread, are not separated radially by any object, for example by any layer, reinforcement or strip interposed radially between the objects in question that are directly radially in contact with one another.

So as to preferentially guarantee effective triangulation of the crown of the tyre, the main direction of the or each hooping filamentary reinforcing element, the main direction of each working filamentary reinforcing element and the main direction of each carcass filamentary reinforcing element form, with the circumferential direction of the tyre, in a portion of the tyre lying axially between the axial edges of the axially narrowest layer or reinforcement among the working layer and the hoop reinforcement, paired angles different in absolute value. This is also referred to as a triangular mesh formed by the hooping, working and carcass filamentary reinforcing elements.

In other words, the or each hooping filamentary reinforcing element extending in a main hooping direction, each working filamentary reinforcing element extending in a main working direction, each carcass filamentary reinforcing element extending in a main carcass direction, these hooping, working and carcass directions are in pairs different in the portion of the tyre axially delimited by the axial edges of the axially narrowest layer or reinforcement among the working layer and the hoop reinforcement.

In embodiments in which the main direction of each carcass filamentary reinforcing element has, between the portions, transition zones where the angle is substantially variable, the portion of the tyre lying axially between the axial edges of the axially narrowest layer or reinforcement among the working layer and the hoop reinforcement and in which the main direction of the or each hooping filamentary reinforcing element, the main direction of each working filamentary reinforcing element and the main direction of each carcass filamentary reinforcing element form, with the circumferential direction of the tyre, paired angles different in absolute value, has an axial width equal to at least 40%, preferably at least 50%, of the axial width of the working layer.

In embodiments in which the main direction of each carcass filamentary reinforcing element has, between the portions, transition zones where the angle is substantially variable, the portion of the tyre lying axially between the axial edges of the axially narrowest layer or reinforcement among the working layer and the hoop reinforcement and in which the main direction of the or each hooping filamentary reinforcing element, the main direction of each working filamentary reinforcing element and the main direction of each carcass filamentary reinforcing element form, with the circumferential direction of the tyre, paired angles different in absolute value, has an axial width equal to at most 90%, preferably at most 80%, of the axial width of the working layer.

Preferably, the median plane of the tyre intersects this portion of the tyre lying axially between the axial edges of the axially narrowest layer or reinforcement among the working layer and the hoop reinforcement. More preferably, this portion of the tyre lying axially between the axial edges of the axially narrowest layer or reinforcement among the working layer and the hoop reinforcement is axially centred on the median plane of the tyre.

In order to even further improve the triangulation of the crown of the tyre, the main direction of each working filamentary reinforcing element and the main direction of each carcass filamentary reinforcing element form, with the circumferential direction of the tyre, in a portion of the tyre lying axially between the axial edges of the working layer, angles of opposite orientations.

In embodiments in which the main direction of each carcass filamentary reinforcing element has, between the portions, transition zones where the angle is substantially variable, the portion of the tyre lying axially between the axial edges of the working layer and in which the main direction of each working filamentary reinforcing element and the main direction of each carcass filamentary reinforcing element form, with the circumferential direction of the tyre, angles of opposite orientations, has an axial width equal to at least 40%, preferably at least 50%, of the axial width of the working layer.

In embodiments in which the main direction of each carcass filamentary reinforcing element has, between the portions, transition zones where the angle is substantially variable, the portion of the tyre lying axially between the axial edges of the working layer and in which the main direction of each working filamentary reinforcing element and the main direction of each carcass filamentary reinforcing element form, with the circumferential direction of the tyre, angles of opposite orientations, has an axial width equal to at most 90%, preferably at most 80%, of the axial width of the working layer.

Preferably, the median plane of the tyre intersects this portion of the tyre lying axially between the axial edges of the working layer. More preferably, this portion of the tyre lying axially between the axial edges of the working layer is axially centred on the median plane of the tyre.

A preferential compromise in performance of the tyre is obtained when:
the main direction of each working filamentary reinforcing element forms, with the circumferential direction of the tyre, an angle ranging, in absolute value, from 15° to 50°, preferably from 18° to 30°,
the main direction of each carcass filamentary reinforcing element forms, with the circumferential direction of the tyre, an angle, in absolute value, greater than or equal to 10°, preferably ranging from 20° to 75° and more preferably ranging from 35° to 70°, in the portion of the carcass layer extending axially in radial line with the working layer.

In one embodiment making it possible to easily anchor the carcass reinforcement in each bead, each bead comprises at least one circumferential reinforcing element, the carcass layer comprising a portion of the carcass layer wound around each circumferential reinforcing element, the main direction of each carcass filamentary reinforcing element forms, with the circumferential direction of the tyre, an angle of each carcass filamentary reinforcing element, in absolute value, strictly greater than 0°, preferably ranging from 27° to 150° and more preferably ranging from 56° to 123°, in the wound portion of the carcass layer.

Advantageously, the filamentary reinforcing elements of each layer are embedded in an elastomeric matrix. The various layers can comprise the same elastomeric matrix or else different elastomeric matrices.

An elastomeric matrix is understood to be a matrix that exhibits elastomeric behaviour in the crosslinked state. Such a matrix is advantageously obtained by crosslinking a composition comprising at least one elastomer and at least one other component. Preferably, the composition comprising at least one elastomer and at least one other component comprises an elastomer, a crosslinking system and a filler. The compositions used for these layers are conventional compositions for calendering reinforcers, typically based on natural rubber or other diene elastomer, a reinforcing filler such as carbon black, a curing system and usual additives. The adhesion between the filamentary reinforcing elements and the matrix in which they are embedded is ensured for example by an ordinary adhesive composition, for example an adhesive of the RFL type or an equivalent adhesive.

Advantageously, each working filamentary reinforcing element is metallic. The expression metallic filamentary element is understood to mean by definition a filamentary element formed from one or an assembly of a plurality of elementary monofilaments made entirely (for 100% of the threads) of a metallic material. Such a metallic filamentary element is preferably implemented with one or more threads made of steel, more preferably of pearlitic (or ferritic-pearlitic) carbon steel referred to as “carbon steel” below, or made of stainless steel (by definition steel comprising at least 11% chromium and at least 50% iron). However, it is of course possible to use other steels or other alloys. If a carbon steel is advantageously used, its carbon content (% by weight of steel) preferably ranges from 0.05% to 1.2%, in particular from 0.5% to 1.1%; these contents represent a good compromise between the mechanical properties required for the tyre and the feasibility of the threads. The metal or the steel used, whether it is in particular a carbon steel or a stainless steel, may itself be coated with a metallic layer which improves for example the properties of implementing the metallic cord and/or its constituent elements, or the use properties of the cord and/or of the tyre themselves, such as properties of adhesion, corrosion resistance or resistance to ageing. According to a preferred embodiment, the steel used is covered with a layer of brass (Zn—Cu alloy) or of zinc. Each metallic elementary monofilament is, as described above, preferably made of carbon steel, and has a mechanical strength ranging from 1000 MPa to 5000 MPa. Such mechanical strengths correspond to the steel grades commonly encountered in the field of tyres, namely the NT (Normal Tensile), HT (High Tensile), ST (Super Tensile), SHT (Super High Tensile), UT (Ultra Tensile), UHT (Ultra High Tensile) and MT (Mega Tensile) grades, the use of high mechanical strengths potentially allowing improved reinforcement of the matrix in which the cord is intended to be embedded and lightening of the matrix reinforced in this way. The one or the assembly of a plurality of elementary monofilaments can be coated with a polymeric material, for example as described in US20160167438.

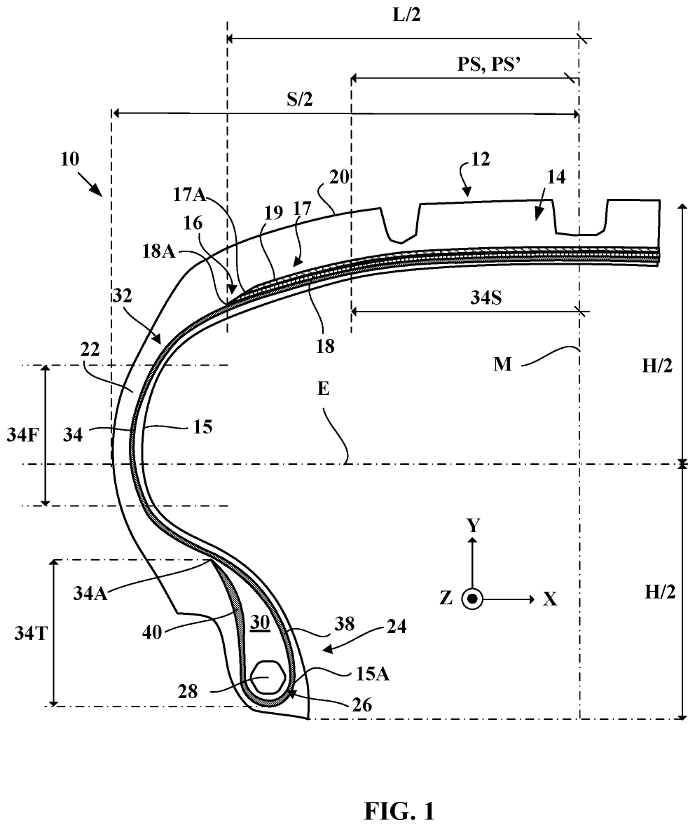

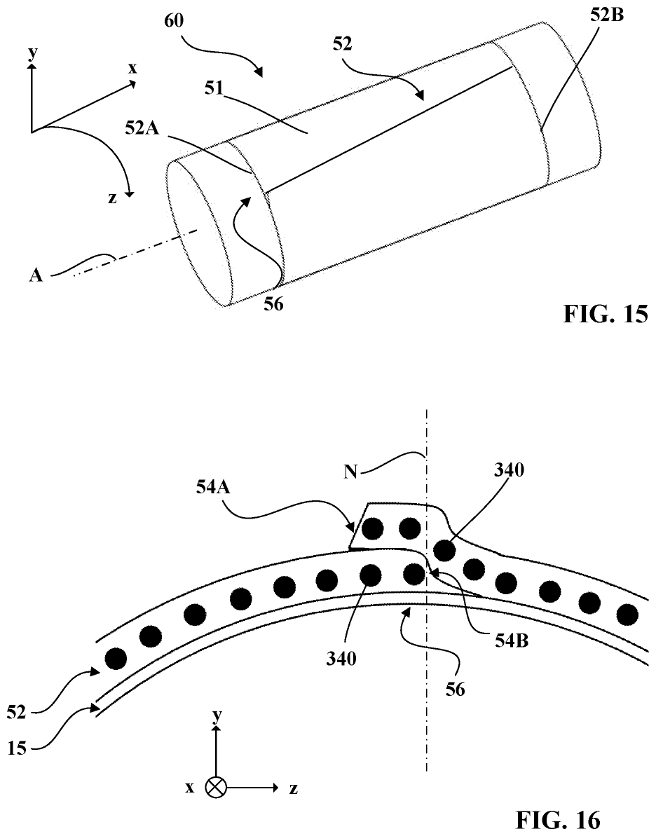

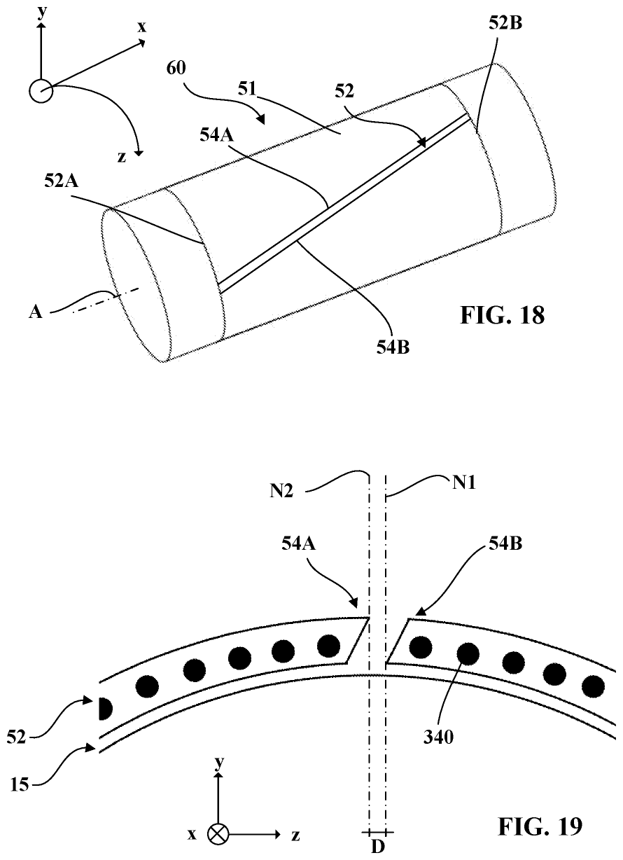

The invention as well as its advantages will be easily understood in the light of the detailed description and of the nonlimiting exemplary embodiments which follow, as well as of FIGS. 1 to 19 relating to these examples in which:

FIG. 1 is a view in section in a meridian section plane of a tyre according to the invention;

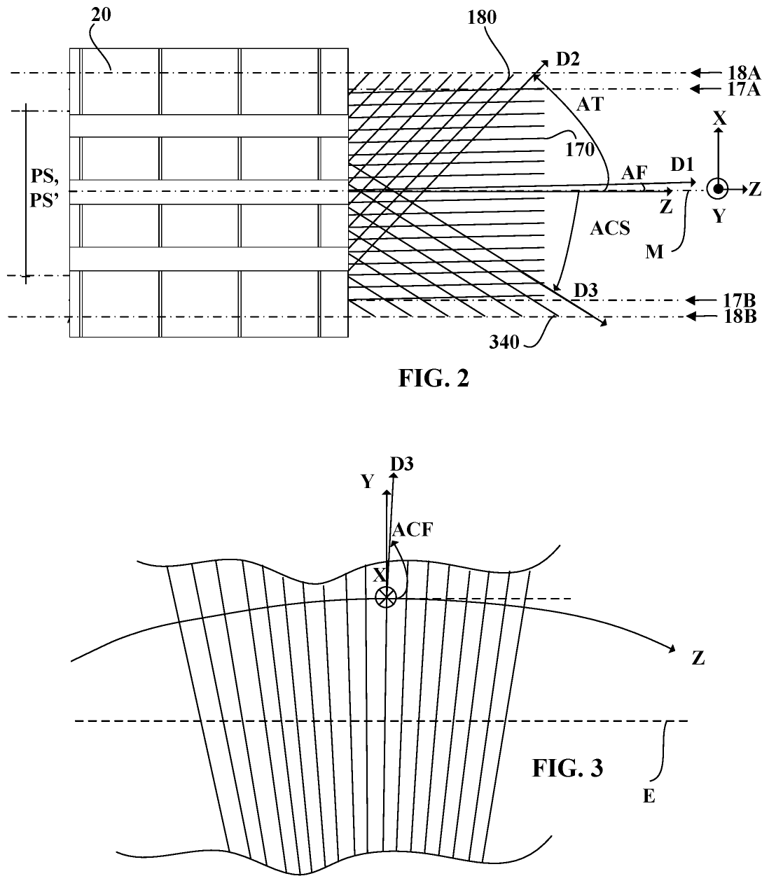

FIG. 2 is a schematic cutaway view of the tyre of FIG. 1 illustrating the arrangement of the filamentary reinforcing elements in radial line with and radially overhanging the working layer;

FIG. 3 is a schematic view of the carcass filamentary reinforcing elements arranged in the sidewall of the tyre of FIG. 1;

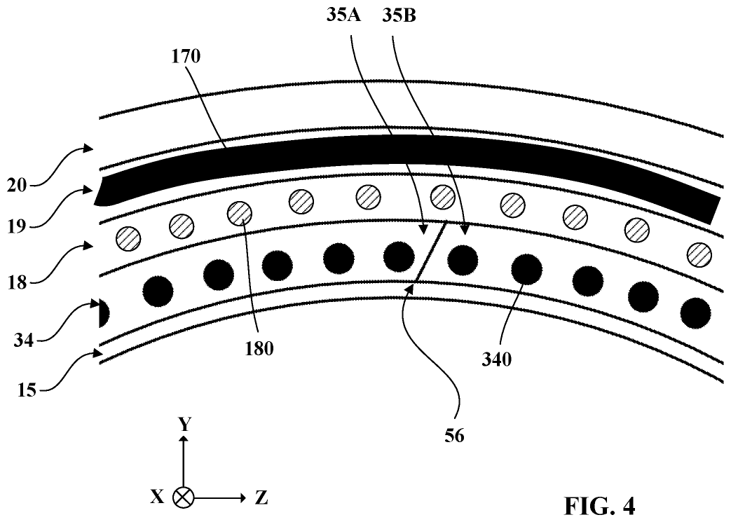

FIG. 4 is a view in a section plane perpendicular to the axial direction of a portion of the crown of the tyre of FIG. 1;

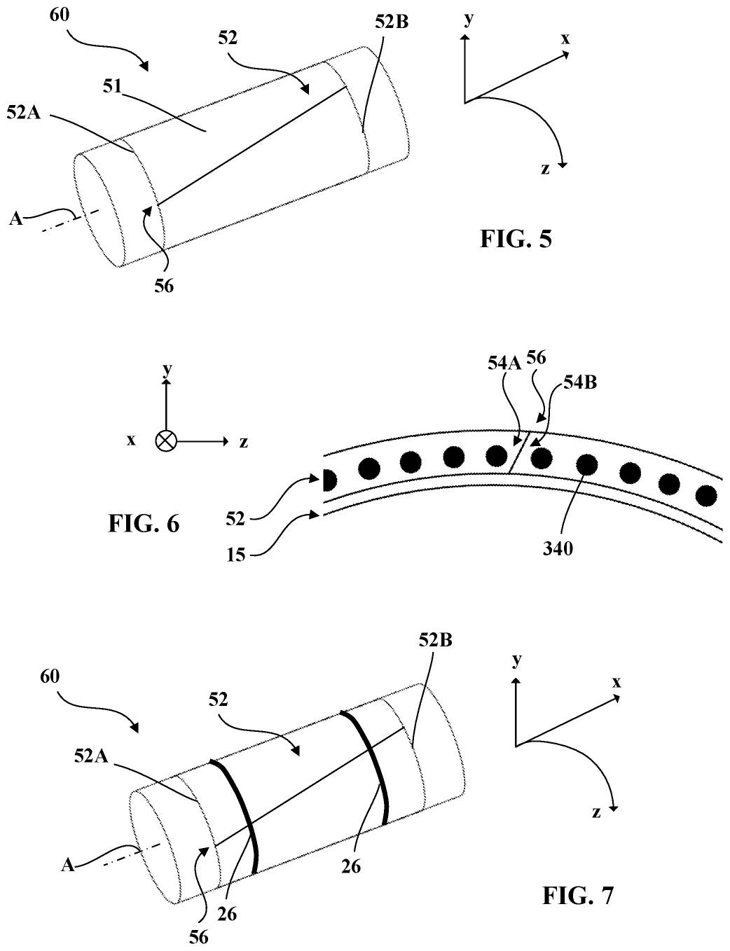

FIGS. 5 to 13 illustrate the different steps of a method according to a first embodiment of the invention making it possible to manufacture the tyre of FIG. 1;

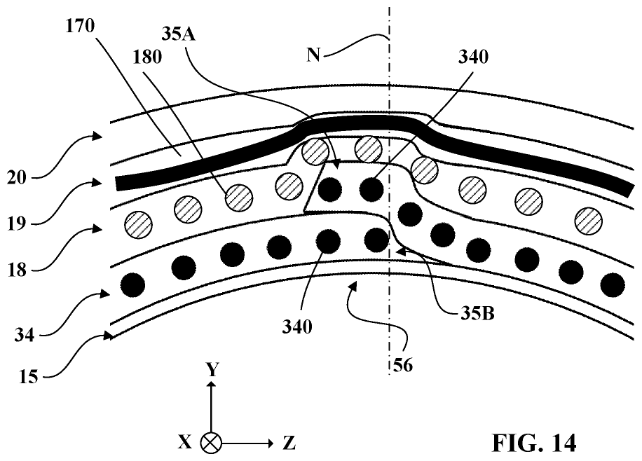

FIGS. 14 to 16 illustrate steps of a method according to a second embodiment of the invention similar to those illustrated by FIGS. 4 to 6; and

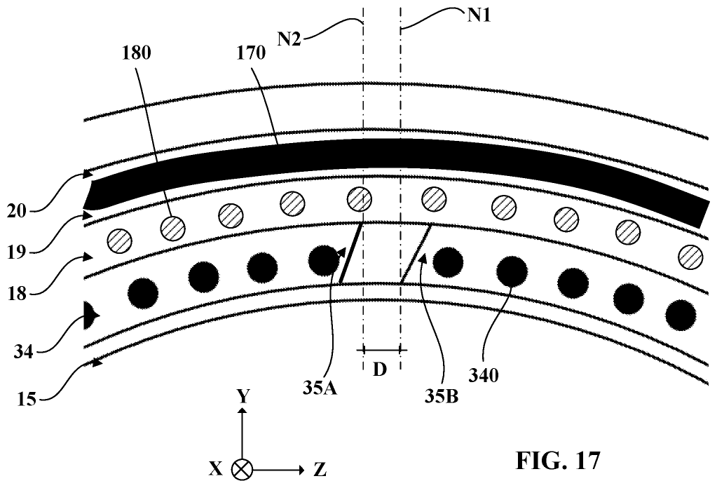

FIGS. 17 to 19 illustrate steps of a method according to a third embodiment of the invention similar to those illustrated by FIGS. 4 to 6.

In the figures relating to the tyre, there is shown a reference frame X, Y, Z corresponding to the usual axial (X), radial (Y) and circumferential (Z) directions, respectively, of a tyre. In the figures relating to the method, there is shown a reference frame x, y, z corresponding to the usual axial (x), radial (y) and circumferential (z) directions, respectively, of a manufacturing support deformable between a substantially cylindrical shape and a toric shape around the x axis.

FIG. 1 shows a tyre according to the invention and denoted by the general reference 10. The tyre 10 is substantially of revolution about an axis substantially parallel to the axial direction X. The tyre 10 is here intended for a passenger vehicle and has dimensions 245/45R18.

The tyre 10 comprises a crown 12 comprising a tread 20 intended to come into contact with the ground during rolling and a crown reinforcement 14 extending in the crown 12 in the circumferential direction Z. The tyre 10 also comprises a sealing layer 15 for sealing against an inflation gas and being intended to delimit an internal cavity closed with a mounting support for the tyre 10 once the tyre 10 has been mounted on the mounting support, for example a rim. The sealing layer 15 is based on butyl.

The crown reinforcement 14 comprises a working reinforcement 16 comprising a working layer 18 and a hoop reinforcement 17 comprising a single hooping layer 19. Here, the working reinforcement 16 comprises a single working layer 18 and is, in this case, made up of the single working layer 18. In what follows, mention will be made, for the sake of simplification, of the working layer 18 without restating each time that this layer is unique. The hoop reinforcement 17 consists of the hooping layer 19.

The crown reinforcement 14 is surmounted radially by the tread 20. Here, the hoop reinforcement 17, here the hooping layer 19, is arranged radially outside the working reinforcement 16 and is therefore radially interposed between the working reinforcement 16 and the tread 20. In the embodiment illustrated in FIG. 2, the hoop reinforcement 17 has an axial width smaller than the axial width of the working layer 18. Thus, the hoop reinforcement is axially the narrowest of the working layer 18 and of the hoop reinforcement 17.

The tyre 10 comprises two sidewalls 22 extending the crown 12 radially inwards. The tyre 10 further comprises two beads 24 radially inside the sidewalls 22. Each sidewall 22 connects each bead 24 to the crown 12.

Each bead 24 comprises at least one circumferential reinforcing element 26, in this case a bead wire 28 surmounted radially by a mass of filling rubber 30.

The tyre 10 comprises a carcass reinforcement 32 anchored in each bead 24. The carcass reinforcement 32 extends in each sidewall 22 and radially internally at the crown 12. The crown reinforcement 14 is arranged radially between the tread 20 and the carcass reinforcement 32.

The carcass reinforcement 32 comprises a carcass layer 34. Here, the carcass reinforcement 32 comprises at least one carcass layer 34, and in this case comprises a single carcass layer 34 and here consists of the single carcass layer 34.

The carcass layer 34 comprises a portion 34T of the carcass layer 34 wound around each circumferential reinforcing element 26 so as to form in each bead 24 an axially inner portion 38 and an axially outer portion 40. The mass of filling rubber 30 is interposed between the axially inner and outer portions 38, 40. Other methods of anchoring the carcass layer 34 are possible, for example as described in U.S. Pat. No. 5,702,548.

Each working 18, hooping 19 and carcass 34 layer comprises an elastomeric matrix in which are embedded one or more filamentary reinforcing elements of the corresponding layer. These layers will now be described with reference to FIGS. 1 to 3.

The hoop reinforcement 17, here the hooping layer 19, is axially delimited by two axial edges 17A, 17B of the hoop reinforcement 17. The hoop reinforcement 17 comprises a plurality of hooping filamentary reinforcing elements 170 wound circumferentially helically so as to extend axially from the axial edge 17A to the other axial edge 17B of the hooping layer 17 in a main direction D1 of each hooping filamentary reinforcing element 170. The main direction D1 forms, with the circumferential direction Z of the tyre 10, an angle AF, in absolute value, less than or equal to 10°, preferably less than or equal to 7° and more preferably less than or equal to 5°. Here, AF=5°.

The working layer 18 is axially delimited by two axial edges 18A, 18B of the working layer 18. The working layer 18 comprises working filamentary reinforcing elements 180 extending axially from the axial edge 18A to the other axial edge 18B of the working layer 18 substantially parallel to one another. Each working filamentary reinforcing element 180 extends in a main direction D2 of each working filamentary reinforcing element 180. The direction D2 forms, with the circumferential direction Z of the tyre 10, an angle AT, in absolute value, strictly greater than 10°, preferably ranging from 15° to 50° and more preferably ranging from 18° to 30°. Here, AT=24°.

The carcass layer 34 is axially delimited by two axial edges 34A, 34B of the carcass layer 34. The carcass layer 34 comprises carcass filamentary reinforcing elements 340 extending axially from the axial edge 34A to the other axial edge 34B of the carcass layer 34.

Each carcass filamentary reinforcing element 340 extends in a main direction D3 of each carcass filamentary reinforcing element 340 forming, with the circumferential direction Z of the tyre 10, an angle ACS, in absolute value, strictly less than 80° in a portion 34S of the carcass layer 34 extending axially in radial line with the working layer 18. Advantageously, in this portion 34S of the carcass layer 34 extending axially in radial line with the working layer 18, the main direction D3 of each carcass filamentary reinforcing element 340 forms, with the circumferential direction Z of the tyre 10, an angle ACS, in absolute value, greater than or equal to 10°, preferably ranging from 20° to 75° and more preferably ranging from 35° to 70°. Here, ACS=43°.

The portion 34S of the carcass layer 34 extending axially in line with the working layer 18 has an axial width equal to at least 40%, preferably at least 50%, of the axial width L of the working layer 18 and equal to at most 90%, preferably at most 80%, of the axial width L of the working layer 18 and in this case equal to 60% of the working layer 18. The median plane M of the tyre 10 intersects this portion 34S. More preferably, this portion 34S is axially centred on the median plane M of the tyre 10.

As illustrated in FIGS. 1 and 3, the main direction D3 of each carcass filamentary reinforcing element 340 forms, with the circumferential direction Z of the tyre 10, an angle ACF ranging, in absolute value, from 80° to 90° in at least one portion 34F of the carcass layer 34 extending radially in each sidewall 22. Here, ACF=90°.

Each portion 34F of the carcass layer 34 extending radially in each sidewall 22 has a radial height equal to at least 5%, preferably at least 15% and more preferably at least 30%, of the radial height H of the tyre 10 and equal to at most 80%, preferably at most 70% and more preferably at most 60%, of the radial height H of the tyre 10 and in this case equal to 41% of the radial height H of the tyre 10. The equatorial circumferential plane E of the tyre 10 intersects each portion 34F of the carcass layer 34 located in each sidewall 22.

The main direction D3 of each carcass filamentary reinforcing element 340 forms, with the circumferential direction Z of the tyre 10, an angle ACT, in absolute value, strictly greater than 0°, preferably ranging from 27° to 150° and more preferably ranging from 56° to 123°, in the wound portion 34T of the carcass layer 34.

Referring to FIG. 4, the carcass layer 34 has two circumferential end edges 35A, 35B facing each other and being in contact with one another. In this first embodiment, the carcass layer 34 extends circumferentially, forming a junction 56 by abutting face to face between the circumferential end edges 35A, 35B of the carcass layer 34 without forming a radial superposition between a carcass filamentary reinforcing element 340 of one of the circumferential end edges 35A, 35B and a carcass filamentary reinforcing element 340 of the other of the circumferential end edges 35A, 35B at least in the portion 34S of the carcass layer 34 extending axially in radial line with the working layer 18. In this case, the junction 56 by abutting face to face between the circumferential end edges 35A, 35B of the carcass layer 34 without forming a radial superposition between a carcass filamentary reinforcing element 340 of one of the circumferential end edges 35A, 35B and a carcass filamentary reinforcing element 340 of the other of the circumferential end edges 35A, 35B is present over the entire axial width of the carcass layer 34 between the two axial edges 34A, 34B of the carcass layer 34.

Thus, as illustrated in FIG. 2, the main direction D1 of each hooping filamentary reinforcing element 170, the main direction D2 of each working filamentary reinforcing element 180 and the main direction D3 of each carcass filamentary reinforcing element 340 form, with the circumferential direction Z of the tyre 10, in a portion PS′ of the tyre 10 lying axially between the axial edges 17A, 17B of the hoop reinforcement 17, paired angles different in absolute value. In addition, the main direction D2 of each working filamentary reinforcing element 180 and the main direction D3 of each carcass filamentary reinforcing element 340 form, with the circumferential direction Z of the tyre 10, in a portion PS of the tyre 10 lying axially between the axial edges 18A, 18B of the working layer 18, angles AT and ACS of opposite orientations. In this case, AT=−24° and ACS=+43°.

In the embodiment described, each portion PS, PS′ of the tyre 10 has an axial width equal to at least 40%, preferably at least 50%, of the axial width L of the working layer 18 and equal to at most 90%, preferably at most 80%, of the axial width L of the working layer 18 and in this case equal to 60% of the axial width L of the working layer 18. The median plane M of the tyre 10 intersects each portion PS, PS′ of the tyre 10. More preferably, each portion PS, PS′ of the tyre 10 is axially centred on the median plane M of the tyre 10.

Each working filamentary reinforcing element 180 is an assembly of two steel monofilaments that each have a diameter equal to 0.30 mm, the two steel monofilaments being wound together at a pitch of 14 mm.

Each carcass filamentary reinforcing element 340 conventionally comprises two multifilament strands, each multifilament strand consisting of a monofilament yarn of polyesters, here of PET, these two multifilament strands being individually over-twisted at 240 turns per metre in one direction and then twisted together at 240 turns per metre in the opposite direction. These two multifilament strands are wound in a helix around one another. Each of these multifilament strands has a count equal to 220 tex.

Each hooping filamentary reinforcing element 170 is formed for example by a cord as described in WO2016166056, WO2016166057, WO2019122620, WO2016091809, WO2016091810, WO2016091811 or WO2016091812.

The tyre 10 is obtained by a method which will be described with reference to FIGS. 5 to 13.

First, a wound working assembly 50 and a wound carcass assembly 52 are made by arranging the filamentary reinforcing elements 180 and 340 of each assembly 50 and 52 parallel to one another and embedding them, for example by calendering, in an uncrosslinked composition comprising at least one elastomer, the composition being intended to form an elastomeric matrix once crosslinked. A ply known as a straight ply is obtained, in which the filamentary reinforcing elements are parallel to one another and are parallel to the main direction of the ply. Then, portions of each straight ply are cut at a cutting angle and these portions are butted against one another so as to obtain a ply known as an angled ply, in which the filamentary reinforcing elements of the ply are parallel to one another and form an angle with the main direction of the ply equal to the cutting angle.

In the embodiment described, there is obtained on the one hand a single working ply 49 and a single carcass ply 51, the axial width of each of which, that is to say the dimension in a direction perpendicular to the longitudinal edges of each ply, is equal to the axial width respectively of each wound working 50 and carcass 52 assembly which will be formed subsequently.

In a first assembly step of a green blank, there is formed, by winding a sealing ply around a support 60 having a substantially cylindrical shape around its main axis A, the sealing layer 15 (not shown in FIG. 5). The support 60 has a substantially cylindrical laying surface with a radius equal to 235 mm.

Then, with reference to FIG. 5, radially outside the sealing layer, there is formed, by winding the carcass ply 51 around the support 60, the wound carcass assembly 52 intended to form the carcass layer 34. The wound carcass assembly 52 is axially delimited by two axial edges 52A, 52B of the carcass assembly 52 and comprises the carcass filamentary reinforcing elements 340 extending substantially parallel to one another axially from the axial edge 52A to the other axial edge 52B of the wound carcass assembly 52. Each carcass filamentary reinforcing element 340 extends, in the carcass ply 51, in a main direction K3 of each carcass filamentary reinforcing element 340 of the carcass ply 51. Referring to FIG. 9, the main direction K3 forms, with the circumferential direction z of the support 60, an initial angle A3 of each carcass filamentary reinforcing element 340, in absolute value, strictly greater than 0°, preferably ranging from 27° to 150° and more preferably ranging from 56° to 123°. Here, A3=75°.

Referring to FIG. 6, the wound carcass assembly 52 has two circumferential end edges 54A, 54B extending axially from the axial edge 52A to the other axial edge 52B of the carcass assembly 52. Each circumferential end edge 54A, 54B of the carcass assembly 52 is intended to form, in the tyre 10, each circumferential end edge 35A, 35B of the carcass layer 34.

During the step of forming the carcass assembly 52, the wound carcass assembly 52 is formed so as to form the junction 56 between the two circumferential end edges 54A, 54B by abutting face to face without forming a superposition between a carcass filamentary reinforcing element 340 of one of the circumferential end edges 54A, 54B and a carcass filamentary reinforcing element 340 of the other of the circumferential end edges 54A, 54B, at least in the portion 52S of the wound carcass assembly 52 intended to extend axially in radial line with the wound working assembly 50 and here over the entire axial width of the wound carcass assembly 52 between the two axial edges 52A, 52B of the wound carcass assembly 52.

The portion 52S of the wound carcass assembly 52 is intended to form the portion 34S of the carcass layer 34.

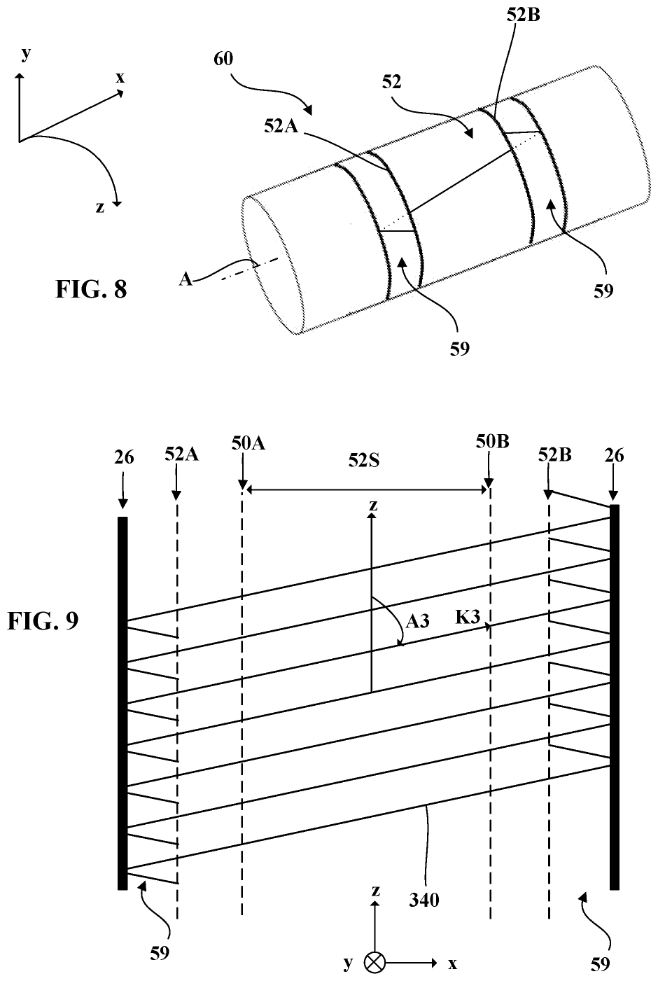

Referring to FIGS. 7 and 8, then, the two circumferential reinforcing elements 26 are arranged around the wound carcass assembly 52 and each axial edge 52A, 52B of the wound carcass assembly 52 is turned axially inwards so as to radially cover each circumferential reinforcing element 26 by each axial edge 52A, 52B of the wound carcass assembly 52 and to form a portion 59 of the wound carcass assembly 52 wound around each circumferential reinforcing element 26. The portion 59 of the wound carcass assembly 52 is intended to form the portion 34T of the carcass layer 34 wound around each circumferential reinforcing element 26 in the tyre.

There is shown in FIG. 9 a diagram illustrating the arrangement of the carcass filamentary reinforcing elements 340 at the end of the step of axially turning the axial edges 52A, 52B of the wound carcass assembly 52 around the circumferential reinforcing elements 26. This figure shows the initial angle A3 described above as well as the various portions 52S and 59.

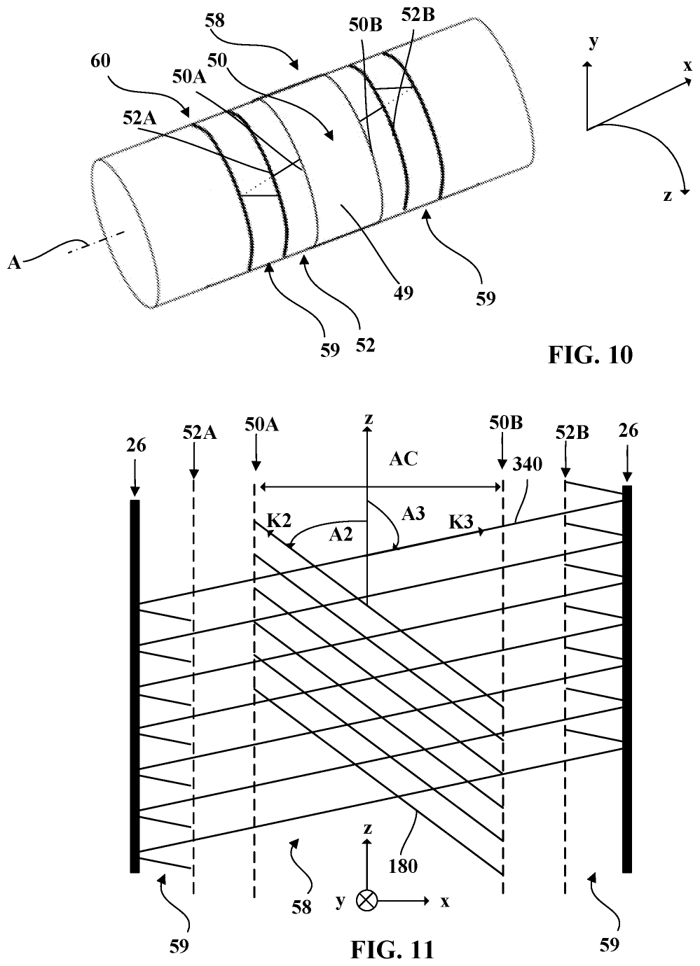

Then, with reference to FIG. 10, there is formed, by winding the working ply 49, radially outside the wound carcass assembly 52, the wound working assembly 50 intended to form the working layer 18. The wound working assembly 50 is axially delimited by two axial edges 50A, 50B of the wound working assembly 50 and comprises the working filamentary reinforcing elements 180 extending substantially parallel to one another axially from the axial edge 50A to the other axial edge 50B of the wound working assembly 50. Each working filamentary reinforcing element 180 extends, in the working ply 49, in a main direction K2 of each working filamentary reinforcing element 180 in the working ply 49. With reference to FIG. 11, the main direction K2 forms, with the circumferential direction z of the support 60, an initial angle A2 of each working filamentary reinforcing element 180, in absolute value, strictly greater than 0°, preferably ranging from 4° to 60° and more preferably ranging from 16° to 47°. Here, A2=35°.

The wound carcass assembly 52 and the wound working assembly 50 then form an assembly 58 of substantially cylindrical shape around the main axis A of the support 60.

There is shown in FIG. 11 a diagram similar to that of FIG. 9 illustrating the arrangement of the carcass filamentary reinforcing elements 340 and the working filamentary reinforcing elements 180 at the end of the step of forming the wound working assembly 50. In this figure, the initial angles A2 and A3 have been shown.

The main direction K2 of each working filamentary reinforcing element 180 and the main direction K3 of each carcass filamentary reinforcing element 340 form, with the circumferential direction z of the support 60, in a portion AC of the assembly 58 lying axially between the axial edges 50A, 50B of the wound working assembly 50, initial angles A2 and A3 of opposite orientations. In this case, A2=−35° and A3=+75°.

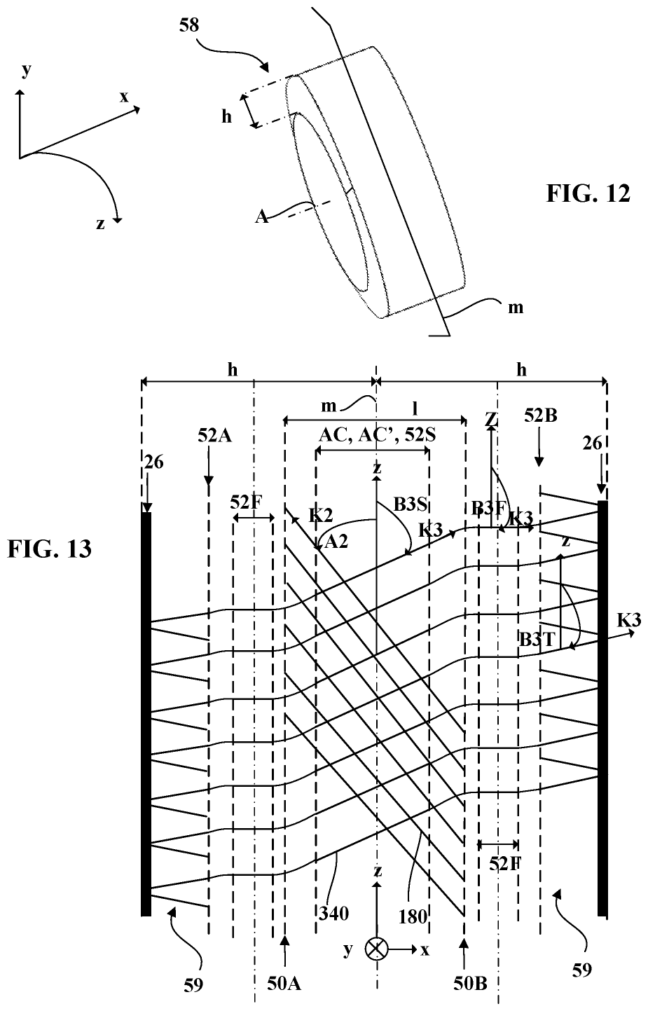

Then, the assembly 58 of substantially cylindrical shape around the main axis A of the support 60 is deformed so as to obtain the assembly 58 of substantially toric shape around the main axis A of the support 60. The deformed assembly 58 illustrated in FIGS. 12 and 13 is obtained. The laying surface of the support 60 then has, at the level of the median plane of the support, a radius equal to 327 mm.

The assembly 58 of substantially cylindrical shape around the main axis A of the support 60 is deformed so as to obtain an assembly 58 of substantially toric shape around the main axis A of the support 60 so that the main direction K3 of each carcass filamentary reinforcing element 340 forms, with the circumferential direction z of the support 60, a final angle B3S of each carcass filamentary reinforcing element 340, in absolute value, strictly less than 80°, in the portion 52S of the wound carcass assembly 52 extending axially in radial line with the wound working assembly 50. Advantageously, the final angle B3S is, in absolute value, greater than or equal to 10°, preferably ranges from 20° to 75° and more preferably ranges from 35° to 70°. Here, B3S=43°.

The portion 52S of the wound carcass assembly 52 extending axially in radial line with the wound working assembly 50 has an axial width equal to at least 40%, preferably at least 50%, of the axial width I of the wound working assembly 50 and equal to at most 90%, preferably at most 80%, of the axial width I of the wound working assembly 50 and in this case is equal to 60% of the axial width I of the wound working assembly 50. The median plane m of the assembly 58 intersects this portion 52S. More preferably, this portion 52S is axially centred on the median plane m of the assembly 58.

The assembly 58 of substantially cylindrical shape around the main axis A of the support 60 is deformed so as to obtain the assembly 58 of substantially toric shape around the main axis A of the support 60 also so that the main direction K3 of each carcass filamentary reinforcing element 340 forms, with the circumferential direction z of the support 60, a final angle B3F of each carcass filamentary reinforcing element 340 ranging from 80° to 90°, in a portion 52F of the wound carcass assembly 52 intended to extend radially in each sidewall 22 of the tyre 10. Each portion 52F of the wound carcass assembly 52 is intended to form each portion 34F of the carcass layer 34.

Each portion 52F of the wound carcass assembly 52 intended to extend radially in each sidewall 22 has a radial height equal to at least 5%, preferably at least 15% and even more preferably at least 30%, of the radial height H of the manufactured tyre and equal to at most 80%, preferably at most 70% and even more preferably at most 60%, of the radial height H of the manufactured tyre, and in this case is equal to 41% of the radial height H of the manufactured tyre. The equatorial circumferential plane e of the assembly 58 intersects each portion 52F of the wound carcass assembly 52 intended to be located in each sidewall 22.

During the deformation step, the final angle B3T formed by the main direction K3 of each carcass filamentary reinforcing element 340, with the circumferential direction z of the support 60, in the wound portion 59 of the wound carcass assembly 52, is substantially identical to the initial angle A3 before the deformation step.

Finally, the assembly 58 of substantially cylindrical shape around the main axis A of the support 60 is deformed so as to obtain the assembly 58 of substantially toric shape around the main axis A of the support 60 also so that the main direction K2 of each working filamentary reinforcing element 340 forms, with the circumferential direction z of the support 60, a final angle B2 of each working filamentary reinforcing element 340, in absolute value, strictly greater than 10°. Advantageously, the final angle B2 ranges, in absolute value, from 15° to 50°, preferably from 18° to 30° and here B2=24°.

The main direction K2 of each working filamentary reinforcing element 180 and the main direction K3 of each carcass filamentary reinforcing element 340 form, with the circumferential direction z of the support 60, in a portion AC of the assembly 58 lying axially between the axial edges 50A, 50B of the wound working assembly 50, final angles B2 and B3 of opposite orientations. In this case, B2=−24° and B3=+43°.

During the method, a plurality of hooping filamentary reinforcing elements 170, preferably adhered, are embedded in an elastomeric matrix to form a hooping ply.

Then, there is arranged, radially around the assembly 58 previously formed on the support 60, a wound hooping assembly intended to form the hoop reinforcement 17. Here, the wound hooping assembly is formed by helical winding of the hooping ply on a toric shape and then the wound hooping assembly is transferred using a transfer ring radially outside the assembly previously formed. As a variant, the hooping ply may be directly wound circumferentially helically around the assembly previously formed so as to form the wound hooping assembly.

In the illustrated embodiment, the wound hooping assembly has an axial width smaller than the axial width of the wound working assembly 50. Thus, the wound hooping assembly is axially the narrowest of the wound working 50 and wound hooping assemblies.

The angle Al formed by the main direction K1 of each hooping filamentary reinforcing element 170 with the circumferential direction z of the support 60 is, in absolute value, less than or equal to 10°, preferably less than or equal to 7° and more preferably less than or equal to 5° and here equal to 5°.

The main direction K1 of each hooping filamentary reinforcing element 170, the main direction K2 of each working filamentary reinforcing element 180 and the main direction D3 of each carcass filamentary reinforcing element 340 form, with the circumferential direction z of the support 60, in a portion AC of the assembly 58 and of the wound hooping assembly lying axially between the axial edges of the wound hooping assembly, paired angles different in absolute value.

The portion AC′ of the assembly 58 and of the wound hooping assembly lying axially between the axial edges of the wound hooping assembly has an axial width equal to at least 40%, preferably at least 50%, of the axial width L of the wound working assembly 50 and at most 90%, preferably at most 80%, of the axial width L of the wound working assembly 50 and in this case 60% of the axial width L of the wound working assembly 50. The median plane m of the assembly 58 intersects this portion AC′. More preferably, this portion AC′ is axially centred on the median plane m of the assembly 58. Then, there is arranged, radially outside the wound hooping assembly, a strip of polymeric material intended to form the tread 20, so as to form a green blank of the tyre 10. In a variant, the strip of polymeric material intended to form the tread 20 may be arranged radially outside the hooping assembly, then this assembly may be transferred radially outside the assembly 58 previously formed on the support 60. In another variant, it is possible, after having arranged the wound hooping assembly radially around the assembly 58 previously formed on the support 60, to arrange the strip of polymeric material intended to form the tread 20.

The assembly thus formed, called the green blank of the tyre due to the presence of crosslinkable compositions in the uncrosslinked state, is then placed in a mould in order to proceed, on the one hand, to a moulding step and, on the other hand, to a step of crosslinking the crosslinkable compositions. During the moulding step, the green blank is radially and circumferentially expanded, for example by pressurizing a deformable membrane, so as to press the green blank against surfaces of a curing mould.

A second embodiment will now be described with reference to FIGS. 14 to 16. Elements similar to those of the first embodiment are denoted by identical references.

Unlike the tyre according to the first embodiment, the carcass layer 34 extends circumferentially, forming the junction 56 by overlapping so as to form a radial superposition between at least one carcass filamentary reinforcing element 340 of one of the circumferential end edges 35A, 35B and at least one carcass filamentary reinforcing element 340 of the other of the circumferential end edges 35A, 35B at least in the portion 34S of the carcass layer 34 extending axially in radial line with the working layer 18, and here over the entire axial width of the carcass layer 34 between the two axial edges 34A, 34B of the carcass layer 34.

In this case, the radially outermost circumferential end edge 35A of the carcass layer 34 covers the radially innermost circumferential end edge 35B of the carcass layer 34 with at most 4 carcass filamentary reinforcing elements 340, preferably at most 3 carcass filamentary reinforcing elements 340 and even more preferably at most 2 carcass filamentary reinforcing elements 340 and with at least 1 carcass filamentary reinforcing element 340 at least in the portion 34S of the carcass layer 34 extending axially in radial line with the working layer 18 and here over the entire axial width of the carcass layer 34 between the two axial edges 34A, 34B of the carcass layer 34. In this case, the radially outermost circumferential end edge 35A covers the radially innermost circumferential end edge 35B with 2 carcass filamentary reinforcing elements 340 over the entire axial width of the carcass layer 34 between the two axial edges 34A, 34B of the carcass layer 34. In order to determine the number of carcass filamentary reinforcing elements 340 of the radially outermost circumferential end edge 35A covering the radially innermost circumferential end edge 35B, there is determined the meridian plane N perpendicular to the axis of rotation of the tyre passing through the axial end of the carcass filamentary reinforcing element 340 of the radially innermost circumferential end edge 35B closest axially to the axial end face of this edge 35B. Any carcass filamentary reinforcing element 340 of the radially outermost circumferential end edge 35A located on the side of this meridian plane N overhanging the radially innermost circumferential end edge 35B is a carcass filamentary reinforcing element 340 of the radially outermost circumferential end edge 35A covering the radially innermost circumferential end edge 35B.

Unlike the method according to the first embodiment, in the second embodiment, the wound carcass assembly 52 is formed so as to form the junction 56 between the two circumferential end edges 54A, 54B by overlapping so as to form a radial superposition between at least one carcass filament reinforcing element 340 of one of the circumferential end edges 54A, 54B and at least one carcass filamentary reinforcing element 340 of the other of the circumferential end edges 54A, 54B, at least in the portion 52S of the wound carcass assembly 52 intended to extend axially in radial line with the wound working assembly 50. In this case, the wound carcass assembly 52 extends circumferentially, forming the junction 56 by overlapping so as to form a radial superposition between at least one carcass filamentary reinforcing element 340 of one of the circumferential end edges 54A, 54B and at least one carcass filamentary reinforcing element 340 of the other of the circumferential end edges 54A, 54B over the entire axial width of the wound carcass assembly 52 between the two axial edges 52A, 52B of the wound carcass assembly 52.

This forming step is carried out so that, if a step for forming the wound working assembly 50 was not carried out prior to the deformation step, the deformation step, carried out under identical deformation conditions, would lead to an opening of the junction 56. Here, as the step of forming the wound working assembly 50 is carried out prior to the deformation step, no opening of the junction 56 is observed despite a reduced number of filamentary reinforcing elements of the radially outermost circumferential end edge 54A of the wound carcass assembly 52 radially covering the radially innermost circumferential end edge 54B of the wound carcass assembly 52.

Athird embodiment will now be described with reference to FIGS. 17 to 19. Elements similar to those of the previous embodiments are denoted by identical references.

Unlike the tyre according to the first embodiment, the two circumferential end edges 35A, 35B are circumferentially spaced from one another at least in the portion of the carcass layer 34S extending axially in radial line with the working layer 18 and here over the entire axial width of the carcass layer 34 between the two axial edges 35A, 35B of the carcass layer 34. In the example, the circumferential end edges 35A, 35B of the carcass layer 34 are circumferentially spaced apart by an average distance of at most 2.5 mm, preferably of at most 2 mm and more preferably of at most 1 mm, in the portion 34S of the carcass layer 34 extending axially in radial line with the working layer 18 and here over the entire axial width of the carcass layer 34 between the two axial edges 35A, 35B of the carcass layer 34. In this case, the circumferential end edges 35A, 35B of the carcass layer 34 are circumferentially spaced apart by an average distance equal to 1 mm in the portion 34S of the carcass layer 34 extending axially in radial line with the working layer 18 and here over the entire axial width of the carcass layer 34 between the two axial edges 35A, 35B of the carcass layer 34. The average distance is calculated by taking the average of ten distances D measured equally distributed over the axial width of the portion 34S of the carcass layer 34 extending in radial line with the working layer 18. Each distance D is the straight distance between the two meridian planes N1, N2 parallel to the axis of rotation of the tyre and passing respectively through the circumferential end point of each circumferential end edge 35A, 35B.

Unlike the method according to the first embodiment, the wound carcass assembly 52 is formed so that the two circumferential end edges 54A, 54B are circumferentially spaced from one another at least in the portion 52S of the wound carcass assembly 52 intended to extend axially in radial line with the wound working assembly 50, and here over the entire axial width of the wound carcass assembly 52 between the two axial edges 52A, 52B of the wound carcass assembly 52. Similarly to the tyre, the circumferential end edges 54A, 54B of the wound carcass assembly 52 are circumferentially spaced apart by an average distance of at most 2.5 mm, preferably of at most 2 mm and more preferably of at most 1 mm, at least in the portion 52S of the wound carcass assembly 52 intended to extend axially in radial line with the wound working assembly 50, and here over the entire axial width of the wound carcass assembly 52 between the two axial edges 52A, 52B of the wound carcass assembly 52. In this case, the circumferential end edges 54A, 54B of the wound carcass assembly 52 are circumferentially spaced apart by an average distance substantially equal to the average distance measured in the tyre 10, that is to say 1 mm, in the portion 52S of the wound carcass assembly 52 intended to extend axially in radial line with the wound working assembly 50 and here over the entire axial width of the wound carcass assembly 52 between the two axial edges 52A, 52B of the wound carcass assembly 52. Similarly to the tyre 10, the average distance is calculated by taking the average of ten distances D measured equally distributed over the axial width of the portion 52S of the wound carcass assembly 52 intended to extend in radial line with the wound working assembly 50. Each distance D is the straight distance between the two meridian planes N1, N2 parallel to the main axis A of the support 60 and passing respectively through the axial end point of each circumferential end edge 52A, 52B.

The invention is not limited to the above-described embodiments.

1.-15. (canceled)

16. A method for manufacturing a tire (10) comprising a crown (12), two sidewalls (22) and two beads (24), each sidewall (22) connecting each bead (24) to the crown (12), a carcass reinforcement (32) anchored in each bead (24) and extending in each sidewall (22) and radially internally at the crown (12), the carcass reinforcement (32) comprising at least one carcass layer (34), and the crown (12) comprising a tread (20) intended to come into contact with the ground when the tire (10) is rolling and a crown reinforcement (14) arranged radially between the tread (20) and the carcass reinforcement (32), the crown reinforcement (14) comprising a working reinforcement (16) comprising a single working layer (18), the method comprising:
winding a carcass ply (51) or a plurality of carcass plies (51) around a support (60) having a substantially cylindrical shape around a main axis (A), to form at least one wound carcass assembly (52) intended to form the carcass layer (34), the wound carcass assembly (52) being axially delimited by two axial edges (52A, 52B) of the wound carcass assembly (52) and comprising carcass filamentary reinforcing elements (340) extending substantially parallel to one another axially from one axial edge (52A, 52B) to the other axial edge (52A, 52B) of the wound carcass assembly (52), each carcass filamentary reinforcing element (340) extending, in the or each carcass ply (51), in a main direction (K3) of each carcass filamentary reinforcing element (340), the main direction (K3) of each carcass filamentary reinforcing element (340) in the or each carcass ply (51) forming, with the circumferential direction (Z) of the support (60), an initial angle (A3) of each carcass filamentary reinforcing element (340);
winding a working ply (49) or a plurality of working plies (50), radially outside the wound carcass assembly (52), to form a wound working assembly (50) intended to form the working layer (18), the wound working assembly (50) being axially delimited by two axial edges (50A, 50B) of the wound working assembly (50) and comprising working filamentary reinforcing elements (180) extending substantially parallel to one another axially from one axial edge (50A, 50B) to the other axial edge (50A, 50B) of the wound working assembly (50), each working filamentary reinforcing element (180) extending, in the or each working ply (49), in a main direction (K2) of each working filamentary reinforcing element (180) in the or each working ply (49), the main direction (K2) of each working filamentary reinforcing element (180) in the or each working ply (49) forming, with the circumferential direction (Z) of the support (60), an initial angle (A2) of each working filamentary reinforcing element (180), the wound carcass assembly (52) and the wound working assembly (50) forming an assembly (58) of substantially cylindrical shape around the main axis (A) of the support (60); and
deforming the assembly (58) of substantially cylindrical shape around the main axis (A) of the support (60) so as to obtain an assembly (58) of substantially toric shape around the main axis (A) of the support (60) so that:
the main direction (K3) of each carcass filamentary reinforcing element (340) forms, with the circumferential direction (z) of the support (60):
a final angle (B3 S) of each carcass filamentary reinforcing element (340), in absolute value, strictly less than 80°, in a portion (52S) of the wound carcass assembly (52) extending axially in radial line with the wound working assembly (50), and
a final angle (B3F) of each carcass filamentary reinforcing element (340) ranging, in absolute value, from 80° to 90°, in a portion (52F) of the wound carcass assembly (52) intended to extend radially in each sidewall (22), and
the main direction (K2) of each working filamentary reinforcing element (180) forms, with the circumferential direction (z) of the support (60), a final angle (B2) of each working filamentary reinforcing element (180), in absolute value, strictly greater than 10°,
wherein, during the step of forming the wound carcass assembly (52), the wound carcass assembly (52) having two circumferential end edges (54A, 54B) extending axially from one of the axial edges (52A, 52B) to the other of the axial edges (52A, 52B) of the wound carcass assembly (52), one of the following alternatives I, II, III is implemented:
I—the wound carcass assembly (52) is formed so as to form a junction (56) between the two circumferential end edges (54A, 54B) of the wound carcass assembly (52) by abutment without forming a superposition between a carcass filamentary reinforcing element (340) of one of the circumferential end edges (54A, 54B) of the wound carcass assembly (52) and a carcass filamentary reinforcing element (340) of the other of the circumferential end edges (54A, 54B) of the wound carcass assembly (52), at least in a portion (52S) of the wound carcass assembly (52) intended to extend axially in radial line with the wound working assembly (50),
II—the wound carcass assembly (52) is formed so as to form a junction (56) between the two circumferential end edges (54A, 54B) of the wound carcass assembly by overlapping so as to form a radial superposition between at least one carcass filamentary reinforcing element (340) of one of the circumferential end edges (54A, 54B) of the wound carcass assembly and at least one carcass filamentary reinforcing element (340) of the other of the circumferential end edges (54A, 54B) of the wound carcass assembly, at least in the portion (52S) of the wound carcass assembly (52) intended to extend axially in radial line with the wound working assembly (50), so that, without a step of forming the wound working assembly (50) prior to the deformation step, the deformation step would lead to an opening of the junction (56), and
III—the wound carcass assembly (52) is formed so that the two circumferential end edges (54A, 54B) of the wound carcass assembly are circumferentially spaced from one another at least in the portion (52S) of the wound carcass assembly (52) intended to extend axially in radial line with the wound working assembly (50).

17. The method according to claim 16, wherein, during the step of forming the wound carcass assembly (52), one of the alternatives I or II is implemented.

18. The method according to claim 17, wherein, during the step of forming the wound carcass assembly (52), the alternative I is implemented.

19. The method according to claim 16, wherein, subsequent to the step of deforming the assembly (58), there is arranged, radially outside the assembly (58) of substantially toric shape, a wound hooping assembly intended to form a hoop reinforcement (17), the wound hooping assembly being formed by helical winding of at least one hooping filamentary reinforcing element (170) or of a hooping ply obtained by embedding one or more hooping filamentary reinforcing elements (170) in an elastomeric matrix, so as to extend axially from one axial edge to the other axial edge of the wound hooping assembly.

20. The method according to claim 16, wherein the initial angle (A2) formed by the main direction (K2) of each working filamentary reinforcing element (180) with the circumferential direction (z) of the support (60) is, in absolute value, strictly greater than 0°.

21. The method according to claim 16, wherein the initial angle (A3) formed by the main direction (K3) of each carcass filamentary reinforcing element (340) with the circumferential direction (z) of the support (60) is, in absolute value, strictly greater than 0°.

22. The method according to claim 16, wherein the final angle (B2) formed by the main direction (K2) of each working filamentary reinforcing element (180) with the circumferential direction (z) of the support (60) ranges, in absolute value, from 15° to 50°.

23. The method according to claim 16, wherein the final angle (B3S) formed by the main direction (K3) of each carcass filamentary reinforcing element (340) with the circumferential direction (z) of the support (60) is, in absolute value, greater than or equal to 10° in the portion (52S) of the wound carcass assembly (52) extending axially in radial line with the wound working assembly (50).

24. A tire obtained by the method according to claim 16.

25. The tire (10) according to claim 24, wherein the working layer (18) is axially delimited by two axial edges (18A, 18B) of the working layer (18) and comprises the working filamentary reinforcing elements (180) extending axially from one axial edge (18A, 18B) to the other axial edge (18A, 18B) of the working layer (18) substantially parallel to one another in a main direction (D2) of each working filamentary reinforcing element (180) forming, with the circumferential direction (Z) of the tire (10), an angle (AT), in absolute value, strictly greater than 10°, and
wherein the carcass layer (34) is axially delimited by two axial edges (34A, 34B) of the carcass layer (34) and comprises the carcass filamentary reinforcing elements (340) extending axially from one axial edge (34A, 34B) to the other axial edge (34A, 34B) of the carcass layer (34), each carcass filamentary reinforcing element (340) extending in a main direction (D3) of each carcass filamentary reinforcing element (340) forming, with the circumferential direction (Z) of the tire (10):
an angle (ACS), in absolute value, strictly less than 80° in a portion (34S) of the carcass layer (34) extending axially in radial line with the working layer (18), and
an angle (ACF), in absolute value, ranging from 80° to 90° in at least one portion (34F) of the carcass layer (34) extending radially in each sidewall (22).

26. The tire according to claim 24, wherein the crown reinforcement (14) comprises a hoop reinforcement (17) arranged radially outside the working reinforcement (16), the hoop reinforcement (17) being axially delimited by two axial edges (17A, 17B) of the hoop reinforcement (17) and comprising at least one hooping filamentary reinforcing element (170) wound circumferentially helically so as to extend axially from one axial edge (17A, 17B) to the other axial edge (17A, 17B) of the hoop reinforcement (17) in a main direction (D1) of the or each hooping filamentary reinforcing element (170).

27. The tire according to claim 26, wherein the main direction (D1) of the or each hooping filamentary reinforcing element (170), the main direction (D2) of each working filamentary reinforcing element (180) and the main direction (D3) of each carcass filamentary reinforcing element (340) form, with the circumferential direction (Z) of the tire (10), in a portion (PS′) of the tire (10) lying axially between the axial edges of the axially narrowest layer or reinforcement among the working layer (18) and the hoop reinforcement (17), paired angles (D1, D2, D3) different in absolute value.

28. The tire (10) according to claim 24, wherein the main direction (D2) of each working filamentary reinforcing element (180) and the main direction (D3) of each carcass filamentary reinforcing element (340) form, with the circumferential direction (Z) of the tire (10), in a portion (PS) of the tire (10) lying axially between the axial edges (18A, 18B) of the working layer (18), angles (D2, D3) of opposite orientations.

29. The tire (10) according to claim 24, wherein the main direction (D2) of each working filamentary reinforcing element (180) forms, with the circumferential direction (Z) of the tire (10), an angle (AT) ranging, in absolute value, from 15° to 50°.

30. The tire according to claim 24, wherein the main direction (D3) of each carcass filamentary reinforcing element (340) forms, with the circumferential direction (Z) of the tire (10), an angle (ACS), in absolute value, greater than or equal to 10°, in the portion (34S) of the carcass layer (34) extending axially in radial line with the working layer (18).
